(19) United States
(12) Patent Application Publication
(10) Pub. No.: US 2021/0381116 A1
(43) Pub. Date: Dec. 9, 2021

(54) SYSTEM AND METHOD FOR HIGH CONCENTRATION OF MULTIELECTRON PRODUCTS OR CO IN ELECTROLYZER OUTPUT

(71) Applicant: Opus 12 Incorporated, Berkeley, CA (US)

(72) Inventors: Ajay R. Kashi, Berkeley, CA (US); Aya K. Buckley, Berkeley, CA (US); Sichao Ma, Dublin, CA (US); Kendra P. Kuhl, Oakland, CA (US); Sara Hunegnaw, Oakland, CA (US)

(21) Appl. No.: 17/342,406

(22) Filed: Jun. 8, 2021

Related U.S. Application Data
(60) Provisional application No. 62/705,067, filed on Jun. 9, 2020.

(51) Int. Cl. C25B 1/23; C25B 9/23; C25B 11/042; C25B 11/032

(52) U.S. Cl. CPC C25B 1/23; C25B 11/032; C25B 11/042; C25B 9/23

(57) ABSTRACT

Systems and methods for increasing the concentration of a desired product in gas phase output streams of COₓ electrolyzers are described.

### STATEMENT OF GOVERNMENT SUPPORT

This invention was made with Government support under Award Number 1738554 awarded by the National Science Foundation and under Award Number DE-SC0018831-01 awarded by the Department of Energy Office of Science. The Government has certain rights in the invention.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

This disclosure relates generally to the electrolytic carbon oxide reduction field, and more specifically to systems and methods for electrolytic carbon oxide reactor operation for production of carbon monoxide, methane, and multicarbon products.

### BACKGROUND

Membrane electrode assemblies (MEAs) for carbon oxide (COₓ) reduction can include a cathode layer, an anode layer, and a polymer electrolyte membrane (PEM) that provides ionic communication between the cathode layer and the anode layer. Carbon oxide (COₓ) reduction reactors (CRRs) that include such MEAs electrochemically reduce COₓ and produce products such CO, hydrocarbons such as methane and ethylene, and/or oxygen and hydrogen containing organic compounds such as methanol, ethanol, and acetic acid. It can be difficult to obtain high concentration of gas phase products.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

One aspect of the disclosure relates to a system for producing a gas phase multielectron product, including a carbon dioxide (CO₂) reduction reactor including a membrane electrode assembly that includes one or more ion conductive polymer layers and a cathode catalyst for facilitating chemical reduction of carbon dioxide to carbon monoxide; a carbon oxide (COₓ) reduction reactor including an anion-exchange membrane (AEM)-only membrane electrode assembly (MEA) that includes one or more ion conductive polymer layers and a cathode catalyst for facilitating chemical reduction of carbon oxide to the gas phase multielectron product, the COₓ reduction reactor configured to receive an intermediate product stream including carbon monoxide (CO) and unreacted CO₂ from the CO₂ reduction reactor, reduce CO to the multielectron gas phase product, convert at least some of the unreacted CO₂ to bicarbonate, transport the bicarbonate to the anode side of the AEM-only MEA, and output a cathode-side gas phase product stream including the multielectron product, wherein the amount of CO₂ in the gas phase product stream is less than the amount in the intermediate gas phase product stream.

In some embodiments, the CO₂ reduction reactor includes a bipolar MEA. In some embodiments, the CO₂ reduction reactor includes a cation exchange membrane-only MEA. In some embodiments, the CO₂ reduction reactor and the COₓ reduction reactor each include a stack of electrochemical cells each including an MEA.

In some embodiments, the COₓ reduction reactor is configured to output an anode-side stream including O₂ and CO₂, the system further including a separator configured to separate the CO₂ and the O₂ in the anode-side stream; and a mixing unit configured to mix fresh CO₂ with separated CO₂ for inlet to the CO₂ reduction reactor.

In some embodiments, the COₓ reduction reactor is configured to output an anode-side stream including CO₂, the system further a recycle loop configured to recycle the CO₂ from the anode-side stream to the CO₂ reduction reactor.

In some embodiments, the COₓ reduction reactor is configured to output an anode-side stream including CO₂ and O₂, the system further including a separator configured to separate the CO₂ and the O₂ in the anode-side stream; and a mixing unit configured to mix fresh CO₂ with separated CO₂ for inlet to the CO₂ reduction reactor.

In some embodiments, the cathode catalyst for facilitating chemical reduction of carbon dioxide to carbon monoxide includes gold.

In some embodiments, the cathode catalyst for facilitating chemical reduction of carbon oxide to the gas phase multielectron product includes copper.

In some embodiments, the gas phase multielectron product is a hydrocarbon. In some embodiments, the gas phase multielectron product is methane (CH₄). In some embodiments, the gas phase multielectron product is ethylene (CH₂CH₂).

Another aspect of the disclosure relates to a method producing a gas phase multielectron product, the method including reducing CO₂ to CO in a carbon dioxide CO₂ reduction reactor including a membrane electrode assembly that includes one or more ion conductive polymer layers and a cathode catalyst for facilitating chemical reduction of carbon dioxide to carbon monoxide; feeding an intermediate gas phase product stream including carbon monoxide (CO) and unreacted CO₂ from the CO₂ reduction reactor from the CO₂ reduction reactor to a COₓ reduction reactor, the COₓ reduction reactor including an anion-exchange membrane (AEM)-only membrane electrode assembly (MEA) that includes one or more ion conductive polymer layers and a cathode catalyst for facilitating chemical reduction of carbon oxide to the gas phase multielectron product, reducing CO to the multielectron gas phase product, converting at least some of the unreacted CO₂ to bicarbonate, transport the bicarbonate to the anode side of the AEM-only MEA, and output a cathode-side gas phase product stream including the multielectron product, wherein the amount of CO₂ in the gas phase product stream is less than the amount in the intermediate gas phase product stream.

In some embodiments, the CO₂ reduction reactor includes a bipolar MEA. In some embodiments, the CO₂ reduction reactor includes a cation exchange membrane-only MEA.

In some embodiments, the CO₂ reduction reactor and the COₓ reduction reactor each include a stack of electrochemical cells each including an MEA.

In some embodiments, the COₓ reduction reactor outputs an anode-side stream including O₂ and CO₂, the method further includes separating the CO₂ from the O₂ in the anode-side stream, In some such embodiments, the method further includes mixing fresh CO₂ with separated CO₂ for inlet to the CO₂ reduction reactor.

In some embodiments, the COₓ reduction reactor is configured to output an anode-side stream including CO₂ and the method further includes recycling the CO₂ from the anode-side stream to the CO₂ reduction reactor.

In some embodiments, the COₓ reduction reactor is configured to output an anode-side stream including CO₂ and O₂ and the method further includes separating the CO₂ and the O₂ in the anode-side stream. In some such embodiments, the method includes o mix fresh CO₂ with separated CO₂ for inlet to the CO₂ reduction reactor.

In some embodiments, the cathode catalyst for facilitating chemical reduction of carbon dioxide to carbon monoxide includes gold. In some embodiments, the cathode catalyst for facilitating chemical reduction of carbon oxide to the gas phase multielectron product includes copper. In some embodiments, the gas phase multielectron product is a hydrocarbon. In some embodiments, the gas phase multielectron product is methane (CH₄). In some embodiments, the gas phase multielectron product is ethylene (CH₂CH₂).

Another aspect of the disclosure relates to a system for producing CO, including: a carbon dioxide (CO₂) reduction reactor including a membrane electrode assembly that includes one or more ion conductive polymer layers and a cathode catalyst for facilitating chemical reduction of carbon dioxide to carbon monoxide; a carbon oxide (COₓ) reduction reactor including an anion-exchange membrane (AEM)-only membrane electrode assembly (MEA) that includes one or more ion conductive polymer layers and a cathode catalyst for facilitating chemical reduction of carbon dioxide, the COₓ reduction reactor configured to receive an intermediate product stream including carbon monoxide (CO) and unreacted CO₂ from the CO₂ reduction reactor, convert at least some of the unreacted CO₂ to bicarbonate, transport the bicarbonate to the anode side of the AEM-only MEA, and output a cathode-side gas phase product stream including CO, wherein the amount of CO₂ in the gas phase product stream is less than the amount in the intermediate gas phase product stream.

In some embodiments, the CO₂ reduction reactor includes a bipolar MEA. In some embodiments, the CO₂ reduction reactor includes a cation exchange membrane-only MEA. In some embodiments, the CO₂ reduction reactor includes a stack of electrochemical cells each including an MEA and the COₓ reduction reactor includes a stack of electrochemical cells each including an MEA. In some embodiments, the COₓ reduction reactor is configured to receive a carbon-containing anode-side feed stream.

Another aspect of the disclosure relates to a method for producing CO, the method including a carbon dioxide (CO₂) reduction reactor including a membrane electrode assembly that includes one or more ion conductive polymer layers and a cathode catalyst for facilitating chemical reduction of carbon dioxide to carbon monoxide; feeding an intermediate gas phase product stream including carbon monoxide (CO) and unreacted CO₂ from the CO₂ reduction reactor from the CO₂ reduction reactor to a COₓ reduction reactor including an anion-exchange membrane (AEM)-only membrane electrode assembly (MEA) that includes one or more ion conductive polymer layers and a cathode catalyst for facilitating chemical reduction of carbon dioxide, converting at least some of the unreacted CO₂ to bicarbonate, transporting the bicarbonate to the anode side of the AEM-only MEA, and outputting a cathode-side gas phase product stream including CO, wherein the amount of CO₂ in the gas phase product stream is less than the amount in the intermediate gas phase product stream.

In some embodiments, the CO₂ reduction reactor includes a bipolar MEA. In some embodiments, the CO₂ reduction reactor includes a cation exchange membrane-only MEA.

In some embodiments, the CO₂ reduction reactor includes a stack of electrochemical cells each including an MEA and the COₓ reduction reactor includes a stack of electrochemical cells each including an MEA.

In some embodiments, the COₓ reduction reactor is configured to receive a carbon-containing anode-side feed stream.

Another aspect of the disclosure relates to a system for producing a gas phase product, including: a carbon dioxide (CO₂) reduction reactor including an anion-exchange membrane (AEM)-only membrane electrode assembly (MEA) that includes a cathode catalyst for facilitating chemical reduction of CO₂ to the gas phase product; the CO₂ reduction reactor configured to reduce CO₂ to the gas phase product, convert at least some unreacted CO₂ to bicarbonate, transport the bicarbonate to the anode side of the AEM-only MEA for reaction to CO₂, output a cathode-side gas phase product stream including the product, and output an anode-side stream including O₂ and CO₂; a separator configured to separate the CO₂ and the O₂ in the anode-side stream; and a mixing unit configured to mix fresh CO₂ with separated CO₂ for inlet to the CO₂ reduction reactor.

In some embodiments, the gas phase product is carbon monoxide (CO). In some embodiments, the gas phase product is a gas phase multielectron product. In some embodiments, the gas phase multielectron product is a hydrocarbon. In some embodiments, the gas phase multielectron product is methane (CH₄). In some embodiments, the gas phase multielectron product is ethylene (CH₂CH₂). In some embodiments, the CO₂ reduction reactor includes a stack of electrochemical cells each including an MEA.

Another aspect of the disclosure relates to a method for producing a gas phase product, including: reducing carbon dioxide to a gas phase product in a carbon dioxide (CO₂) reduction reactor including an anion-exchange membrane (AEM)-only membrane electrode assembly (MEA) that includes a cathode catalyst for facilitating chemical reduction of CO₂ to the gas phase product; converting at least some unreacted CO₂ to bicarbonate, transporting the bicarbonate to the anode side of the AEM-only MEA for reaction to CO₂, outputting a cathode-side gas phase product stream including the product, and outputting an anode-side stream including O₂ and CO₂; separating the CO₂ from the O₂ in the anode-side stream; and mixing fresh CO₂ with separated CO₂ for inlet to the CO₂ reduction reactor.

In some embodiments, the gas phase product is carbon monoxide (CO). In some embodiments, the gas phase product is a gas phase multielectron product. In some embodiments, the gas phase multielectron product is a hydrocarbon. In some embodiments, the gas phase multielectron product is methane (CH₄). In some embodiments, the gas phase multielectron product is ethylene (CH₂CH₂). In some embodiments, the CO₂ reduction reactor includes a stack of electrochemical cells each including an MEA.

Another aspect of the disclosure relates to a system for producing a gas phase product, including: a carbon dioxide (CO₂) reduction reactor including an anion-exchange membrane (AEM)-only membrane electrode assembly (MEA) that includes a cathode catalyst for facilitating chemical reduction of CO₂ to the gas phase product; the CO₂ reduction reactor configured to reduce CO₂ to the gas phase product, convert at least some unreacted CO₂ to bicarbonate, transport the bicarbonate to the anode side of the AEM-only MEA for reaction to CO₂, output a cathode-side gas phase product stream including the product, receive a carbon-containing anode feed, oxidize the carbon-containing anode feed to CO₂, and output an anode-side product stream including CO₂.

In some embodiments, the system further includes a recycle loop for recycling the CO₂ in the anode-side product stream to the cathode to be reduced. In some embodiments, the gas phase product is carbon monoxide (CO). In some embodiments, the gas phase product is a gas phase multielectron product. In some embodiments, the gas phase multielectron product is a hydrocarbon. In some embodiments, the gas phase multielectron product is methane (CH₄). In some embodiments, the gas phase multielectron product is ethylene (CH₂CH₂).

In some embodiments, the CO₂ reduction reactor includes a stack of electrochemical cells each including an MEA.

In some embodiments, the anode feedstock is one of biogas, natural gas, CO₂ separated from biogas that contains trace methane and/or other hydrocarbons, municipal wastewater, alcohol or aqueous alcohol solutions, steam methane reforming waste streams, and carbon monoxide.

Another aspect of the disclosure relates to a method for producing a gas phase product, including: providing a carbon dioxide (CO₂) reduction reactor including an anion-exchange membrane (AEM)-only membrane electrode assembly (MEA) that includes a cathode catalyst for facilitating chemical reduction of CO₂ to the gas phase product; reducing CO₂ to the gas phase product, converting at least some unreacted CO₂ to bicarbonate, transporting the bicarbonate to the anode side of the AEM-only MEA for reaction to CO₂, outputting a cathode-side gas phase product stream including the product, receiving a carbon-containing anode feed, oxidizing the carbon-containing anode feed to CO₂, and outputting an anode-side product stream including CO₂.

In some embodiments, the method further includes recycling the CO₂ in the anode-side product stream to the cathode to be reduced. In some embodiments, the gas phase product is carbon monoxide (CO). In some embodiments, the gas phase product is a gas phase multielectron product. In some embodiments, the gas phase multielectron product is a hydrocarbon. In some embodiments, the gas phase multielectron product is methane (CH₄). In some embodiments, the gas phase multielectron product is ethylene (CH₂CH₂). In some embodiments, the CO₂ reduction reactor includes a stack of electrochemical cells each including an MEA.

In some embodiments, the anode feedstock is one of biogas, natural gas, CO₂ separated from biogas that contains trace methane and/or other hydrocarbons, municipal wastewater, alcohol or aqueous alcohol solutions, steam methane reforming waste streams, and carbon monoxide.

Another aspect of the disclosure relates to system for producing a gas phase product, the system including: a carbon oxide (COₓ) reduction reactor including a membrane electrode assembly (MEA) that includes one or more ion conductive polymer layers and a cathode catalyst for facilitating chemical reduction of COₓ to the gas phase product, the COx reduction reactor configured to receive a feed stream including COₓ and outlet a gas phase product stream including the gas phase product; and a recycle loop configured to recycle, without separation, a portion of the gas phase product stream such that the feed stream includes a mixture of the portion of the gas phase product stream and fresh CON. In some embodiments, the recycle loop includes a compressor. In some embodiments, the COₓ is carbon dioxide (CO₂). In some embodiments, gas phase product is CO. In some embodiments, the COₓ is carbon monoxide (CO). In some embodiments, the gas phase product is a multielectron product. In some embodiments, the gas phase multielectron product is methane (CH₄). In some embodiments, the gas phase multielectron product is ethylene (CH₂CH₂). In some embodiments, the MEA is a bipolar MEA. In some embodiments, the MEA is an anion-exchange membrane (AEM)-only MEA. In some embodiments, the MEA is a cation-exchange membrane-only MEA. In some embodiments, the MEA includes a liquid buffer layer disposed between the cathode catalyst and one or more ion conductive polymer layers. In some embodiments, the COₓ reduction reactor includes a stack of electrochemical cells each including an MEA.

Another aspect of the disclosure relates to a method of producing gas phase product, including providing a carbon oxide (COₓ) reduction reactor including a membrane electrode assembly (MEA) includes one or more ion conductive polymer layers and a cathode catalyst for facilitating chemical reduction of COₓ to the gas phase product; mixing COₓ with a recycle stream to form a feed stream; feeding the feed stream to COₓ reduction reactor; operating the COₓ reduction reactor at conditions to produce a gas phase product stream including the gas phase product; and recycling a portion of the gas phase product stream, without separation, to form the recycle stream that is mixed with the fresh COₓ.

In some embodiments, the method further includes compressing the recycle stream to compensate for the pressure drop across the COₓ reduction reactor. In some embodiments, the COₓ is carbon dioxide (CO₂). In some embodiments, the gas phase product is CO. In some embodiments, the COₓ is carbon monoxide (CO). In some embodiments, the gas phase multielectron product is a hydrocarbon. In some embodiments, the gas phase multielectron product is methane (CH₄). In some embodiments, the gas phase multielectron product is ethylene (CH₂CH₂).

In some embodiments, the MEA is a bipolar MEA. In some embodiments, the MEA is an anion-exchange membrane (AEM)-only MEA. In some embodiments, the MEA includes a liquid buffer layer disposed between the cathode catalyst and one or more ion conductive polymer layers. In some embodiments, the COₓ reduction reactor includes a stack of electrochemical cells each including an MEA.

Another aspect of the disclosure relates to a system for producing a gas phase product, including: n carbon oxide (COₓ) reduction electrolyzers, each including a membrane electrode assembly (MEA) that includes one or more ion conductive polymer layers and a cathode catalyst for facilitating chemical reduction of COₓ to the gas phase product, each COₓ reduction electrolyzer configured to receive a feed stream including COₓ and outlet a gas phase product stream including the gas phase product, wherein n is an integer greater than 1 and the n COₓ reduction electrolyzers are connected in series such that the feed stream of the n+1^{th} COₓ electrolyzer includes at least part of the output of the n^{th} COₓ electrolyzer.

In some embodiments, the COₓ is carbon dioxide (CO₂). In some embodiments, the gas phase product is carbon monoxide (CO). In some embodiments, the gas phase product is a gas phase multielectron product. In some embodiments, the COₓ is carbon monoxide (CO). In some embodiments, the gas phase product is a gas phase multielectron product. In some embodiments, the gas phase product is methane (CH₄). In some embodiments, gas phase product is ethylene (CH₂CH₂). In some embodiments, the MEAs of the n COₓ reduction electrolyzers are substantially the same. In some embodiments, at least two MEAs of the n COₓ reduction electrolyzers differ in one or more of catalyst type, catalyst loading, or membrane type. In some embodiments, the n COₓ reduction electrolyzers are arranged in a stack. In some such embodiments, the stack of n COₓ reduction electrolyzers is arranged in a superstack of COₓ reduction electrolyzers including a plurality of stacks of COₓ reduction electrolyzers connected in parallel.

In some embodiments, the MEAs are bipolar MEAs. In some embodiments, the MEAs are anion-exchange membrane (AEM)-only MEAs. In some embodiments, the MEAs includes a liquid buffer layer disposed between the cathode catalyst and one or more ion conductive polymer layers.

Another aspect of the disclosure relates to a method for producing a gas phase product, including: providing n carbon oxide (COₓ) reduction electrolyzers, each including a membrane electrode assembly (MEA) that includes one or more ion conductive polymer layers and a cathode catalyst for facilitating chemical reduction of COₓ to the gas phase product, feeding a feed stream to each COₓ reduction electrolyzer, the feed stream including COₓ, and outletting a gas phase product stream including the gas phase product from each COₓ reduction electrolyzer, wherein n is an integer greater than 1 and the n COₓ reduction electrolyzers are connected in series such that the feed stream of the n+1^{th} COₓ electrolyzer includes at least part of the output of the n^{th} COₓ electrolyzer.

Another aspect of the disclosure relates to a system for producing a gas phase product, the system including: a carbon oxide (COₓ) reduction reactor including a membrane electrode assembly (MEA) that includes one or more ion conductive polymer layers, a cathode catalyst for facilitating chemical reduction of COₓ to the gas phase product, and a liquid buffer layer disposed between the cathode catalyst and the one or more ion conductive polymer layers, the COx reduction reactor configured to receive a feed stream including COₓ and outlet a gas phase product stream including the gas phase product.

Another aspect of the disclosure relates to a method for producing a gas phase product, the method including: providing a carbon oxide (COₓ) reduction reactor including a membrane electrode assembly (MEA) that includes one or more ion conductive polymer layers, a cathode catalyst for facilitating chemical reduction of COₓ to the gas phase product, and a liquid buffer layer disposed between the cathode catalyst and the one or more ion conductive polymer layers, providing a feed stream including a carbon oxide to the COx reduction reactor and outletting a gas phase product stream including the gas phase product.

These and other aspects of the disclosure are described further below with reference to the drawings.

### BRIEF DESCRIPTION OF DRAWINGS

FIG. 1 shows an example of a system with an electrochemical cell and a recycle loop according to certain embodiments.

FIG. 2 shows an example of a system including multiple electrochemical cells in series according to certain embodiments.

FIG. 3a shows an example of a system including multiple electrochemical cells stacked in parallel with a single CO₂ flow stream shared between the cells according to certain embodiments.

FIG. 3b shows an example of a system including multiple electrochemical cells arranged in a stacked and connected in series according to certain embodiments.

FIG. 4 shows an example of a system including a single stage CO₂ reduction electrolyzer with an AEM-only MEA according to certain embodiments.

FIG. 5 shows an example of a system including a two-stage CO₂ reduction electrolyzer including an AEM-only MEA according to certain embodiments.

FIG. 6 shows an example of system including an electrolyzer that includes a buffer layer of an aqueous alkaline solution provided between the membrane and the cathode according to certain embodiments.

FIG. 7 shows an example of a system for controlling the operation of a carbon oxide reduction reactor according to certain embodiments.

FIG. 8 shows an example of a system including a direct air CO₂ capture subsystem and an CO₂ reduction electrolyzer subsystem.

FIG. 9 shows an example of a MEA for use in COₓ reduction according to various embodiments.

FIG. 10 shows an example of a CO₂ electrolyzer configured to receive water and CO₂ as a reactant at a cathode and expel CO as a product according to certain embodiments.

FIGS. 11 and 12 show example constructions of COx reduction MEAs according to certain embodiments.

### DESCRIPTION

Provided herein are systems and methods for operating carbon oxide (COₓ) reduction reactors (CRRs) for producing high concentrations of gas phase products including carbon monoxide (CO) and many electron gas products such as methane (CH₄) and ethylene (C₂H₄).

Membrane electrode assemblies (MEAs) for carbon oxide (COₓ) reduction can include a cathode layer, an anode layer, and a polymer electrolyte membrane (PEM) that provides ionic communication between the cathode layer and the anode layer. CRRs that include such MEAs electrochemically reduce COₓ and produce products such CO, hydrocarbons such as methane and ethylene, and/or oxygen and hydrogen containing organic compounds such as methanol, ethanol, and acetic acid.

CO₂ electrolysis can produce a range of products depending on the catalyst, MEA design, and operating conditions used. Hydrogen is also produced as a byproduct of CO₂ electrolysis. This can be useful for some applications where a mixture of H₂ and CO₂ electrolysis product are desired, but in many cases only the CO₂ electrolysis product is desired and it is useful to limit the amount of hydrogen in the product stream. Various catalysts in the cathode of a CRR cause different products or mixtures of products to form from COₓ reduction reactions.

The number of electrons needed to generate CO₂ electrolysis products varies depending on the product. Two electron products, like CO, require two electrons per product molecule. “Many electron products” and “multielectron products” refers to products from reactions that use more than two electrons per product molecule. Examples of possible two electron reactions and many electron reactions at the cathode from CO and CO₂ electrolysis are given below:

CO₂+2H⁺+2e-→CO+H₂O (2 electron)

2CO₂+12H⁺12e⁻→CH₂CH₂+4H₂O (12 electron)

2CO₂+12H⁺12e⁻→CH₃CH₂OH+3H₂O (12 electron)

CO₂+8H⁺8e⁻→CH₄+2H₂O (8 electron)

2CO+8H⁺8e⁻→CH₂CH₂+2H₂O (8 electron)

2CO+8H⁺8e⁻→CH₃CH₂OH+H₂O (8 electron)

CO+6H⁺6e⁻→CH₄+H₂O (6 electron)

CO and CO₂ electrolysis reactions when water is the proton source:

CO₂+H₂O+2e⁻→CO+2OH (2 electron)

2CO₂+8H₂O+12e⁻→CH₂CH₂+12OH (12 electron)

2CO₂+9H₂O+12e⁻→CH₃CH₂OH+12OH (12 electron)

CO₂+6H₂O+8e⁻→CH₄+80H (8 electron)

2CO+10H₂O+8e⁻→CH₂CH₂+8OH (8 electron)

2CO+7H₂O+8e⁻→CH₃CH₂OH+8OH (8 electron)

CO+5H₂O+6e⁻→CH₄+6OH (6 electron)

Further, at levels of electrical potential used for cathodic reduction of CO₂, hydrogen ions may be reduced to hydrogen gas in a parasitic reaction:

2H⁺2e⁻→H₂ (2 electron)

Even at relatively low current efficiencies, the electrolyzer will produce relative high amounts of low electron gas products like CO and H₂. As an example, an electrolyzer that has a 30% current efficiency for ethylene and a 5% current efficiency for hydrogen results in a 1:1 molar C₂H₂:H₂ in the gas outlet stream. This is due to ethylene needing 6 times the number of electrons as hydrogen.

While some many electron products (e.g., ethanol) are liquid at common operating temperatures, many electron products like methane, ethane, ethylene, propane, and propylene are gas phase and mixed with other gas phase products and unreacted COₓ in the product stream.

Another challenge with many electron gas products is water management. Water may be produced during the electrochemical reduction of COₓ per the equations above and/or travel to the cathode side of the electrochemical cell where COₓ reduction occurs through the polymer electrolyte membrane through diffusion, migration, and/or drag. The water should be removed from the electrochemical cell to prevent it from accumulating and blocking reactant COₓ from reaching the catalyst layer.

Higher input flow rates of COₓ will help remove water from the cell. Lower flow rates of COₓ may not be sufficient to push out water, leading to cell flooding, the build-up of water in all or part of the MEA catalyst layer, cathode gas diffusion layer, or flow field. In flooded areas, COₓ will not be able to reach the catalyst at rates necessary to support high current efficiency at high current density, which results in the production of undesired hydrogen gas in place of reduction of COₓ to the desired product.

The gas flow needed through a cell to prevent flooding depends on the flow field design, current density, and gas pressure in the cell. According to various embodiments, a 100 cm² cell may have a flow of at least 100 sccm, 300 sccm, 450 sccm, or 750 sccm to prevent flooding.

While relatively high flow rates can be used for water management, low flow rates are needed for high COₓ utilization for multielectron products. COₓ utilization is the percent of COₓ input to the electrochemical reactor that is converted to a product. Single pass COₓ utilization is the COₓ utilization if the gas passes through the reactor a single time. Parameters such as current density, input COₓ flow rate, current efficiency, and number of electrons needed to reduce COₓ to a product determine the single pass COₓ utilization.

The below examples illustrate how higher COₓ utilization for multielectron products results in lower flow rates. CO Reference Example is a reference example for CO production from 450 sccm of input CO₂ to a 100 cm² electrochemical cell at 600 mA/cm², with Examples 1 and 2 showing single pass utilization and output gas stream composition and flow rate for CH₄ production. Example 1 has the same input flow rate as CO Reference Example and Example 2 has the same single pass utilization.

TABLE 1
Input CO₂ flows and single pass CO₂ utilization for CH₄
production compared with CO production

| | CO Reference | Example 1: | Example 2: |
|---|---|---|---|
| | Example: | CH₄ | CH₄ |
| | CO production | production | production |
| Input CO₂ flow | 450 sccm | 450 sccm | 112.5 sccm |
| Current efficiency | 90% for CO | 90% for CH₄ | 90% for CH₄ |
| | 10% for H₂ | 10% for H₂ | 10% for H₂ |
| Single pass CO₂ | 84% | 21% | 84% |
| utilization | | | |
| Output gas stream | 14.7% CO₂ | 72.3% CO₂ | 11.7% CO₂ |
| | 76.8% CO | 19.2% methane | 61.1% methane |
| | 8.5% H2. | 8.5% H₂ | 27.2% H₂ |
| Output gas flow rate | 492 sccm | 492 sccm | 154.5 sccm |

In the CO Reference Example, 450 sccm results in 84% CO₂ utilization. Using the same input flow rate results in only 21% utilization for methane production in Example 1. To get to a CO₂ utilization of 84%, a lower input flow of 112.5 sccm is used (Example 2). This is four times lower than the input flow required to convert 84% of CO₂ in the input stream to CO (a 2 electron product) at the outlet, vs the flow rate needed to get 84% utilization of CO₂ to methane (an 8 electron product).

Products that contain multiple carbon atoms further exacerbate these difficulties. The flow rate of gas through the electrolyzer is further decreased if multiple gas phase CO₂ molecules are converted to a single gas phase molecule of multicarbon product. Table 2, below, includes Examples 3-5, which show input CO₂ flow rates and single pass utilization for examples of ethylene production.

TABLE 2
Input CO₂ flows and single pass CO₂ utilization for CH₂CH₂ production

| | Example 3: | Example 4: | Example 5: |
|---|---|---|---|
| | CH₂CH₂ | CH₂CH₂ | CH₂CH₂ |
| | production | production | production |
| Input CO₂ flow | 450 sccm | 150 sccm | 450 sccm |
| Current | 90% for CH₂CH₂ | 90% for CH₂CH₂ | 33% for CH₂CH₂ |
| efficiency | 10% for H₂ | 10% for H₂ | 33% for liquid |
| | | | products (e.g., |
| | | | CH₂CH₂OH) |
| | | | 33% for H₂ |
| Single pass | 28% | 84% | |
| CO₂ utilization | | | |
| Output gas | 78.7% CO₂ | 45.3% CO₂ | 68.9% CO₂ |
| stream | 12.8% ethylene | 32.8% ethylene | 4.4% ethylene |
| | 8.5% H₂ | 21.9% H₂ | 26.7% H₂ |
| Output gas | 429 sccm | 129 sccm | 519.3 sccm |
| flow rate | | | |

The product concentration and flow rate are much lower than is possible when a two electron product is made as in the CO Reference Example. In addition, as the gas travels through the reactor, the total flow rate gets lower and lower, making water management more difficult in cases of higher CO₂ utilization.

In Example 5, some of the CO₂ is reacted to form liquid products, which make up 33% of the current efficiency but are not present in the gas phase output of the electrolyzer. Six times as much H₂ is produced compared to ethylene due to the difference in the number of electrons needed to make each product.

The above examples highlight the effect that even small current efficiencies for H₂ have on the concentration of the multielectron CO₂ reduction product coming out of the electrochemical cell. In the CO Reference Example, the H₂ concentration in the output gas stream is 8.5%. To achieve the same utilization, the CH₄ output gas stream contains 27.2% H₂ (Example 2) and the CH₂CH₂ output gas stream contains 21.9% H₂ (Example 4).

In some embodiments, CO is the starting reactant. This can mitigate some of the above described problems because fewer electrons are used to make the each of the many electron products compared to using CO₂ as the starting reactant. Table 3 below shows example output gas streams for CH₄ produced from CO reduction in a 100 cm² cell.

TABLE 3
Input CO flows and single pass CO utilization for CH₄

| | Example 6: | Example 7: |
|---|---|---|
| | CH₄ from CO | CH₄ from CO |
| Input CO flow | 450 sccm | 150 sccm |
| Current efficiency | 90% for CH₄ | 90% for CH₄ |
| | 10% for H₂ | 10% for H₂ |
| Single pass CO₂ | 28% | 84% |
| utilization | | |
| Output gas stream | 65.9% CO | 12.5% CO |
| | 25.6% CH₄ | 65.6% for CH₄ |
| | 8.5% H₂ | 21.9% H₂ |
| Output gas flow rate | 492 sccm | 192 sccm |

Examples 6 and 7 can be compared to Examples 1 and 2, respectively. To get to a CO utilization of 84% (Example 7), the input flow rate is 33% higher for CO than for CO₂ (Example 2).

Provided herein are systems and methods for increasing the concentration of desired product in gas phase output streams of COₓ electrolyzers. While the description below chiefly refers to gas phase many electron products such methane, ethane, ethylene, propane, and propylene, the systems and methods may also be implemented to increase concentration of CO for electrolyzers configured for CO production.

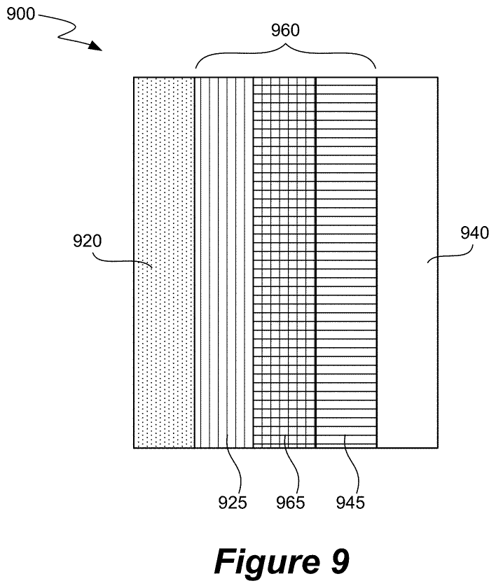

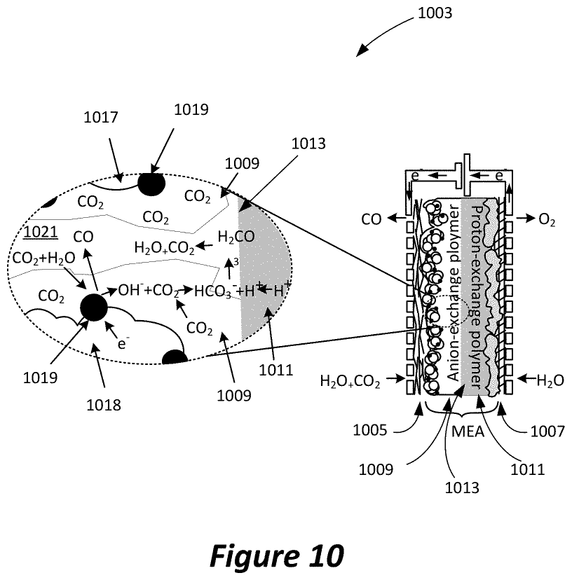

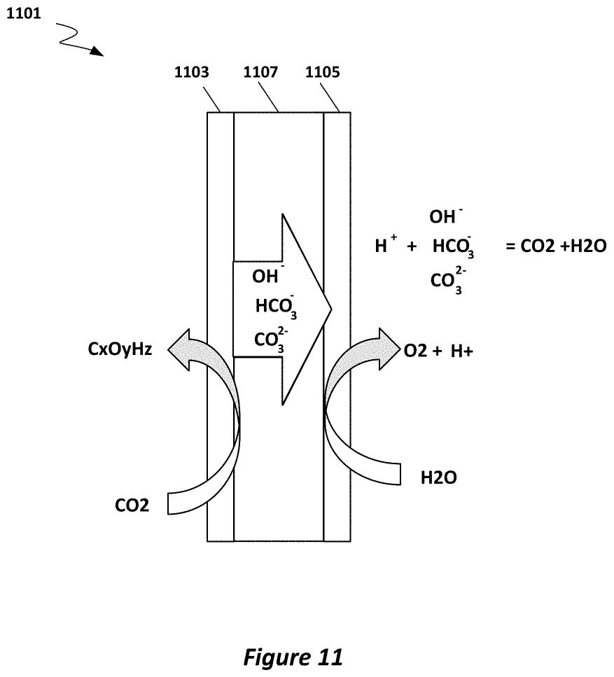

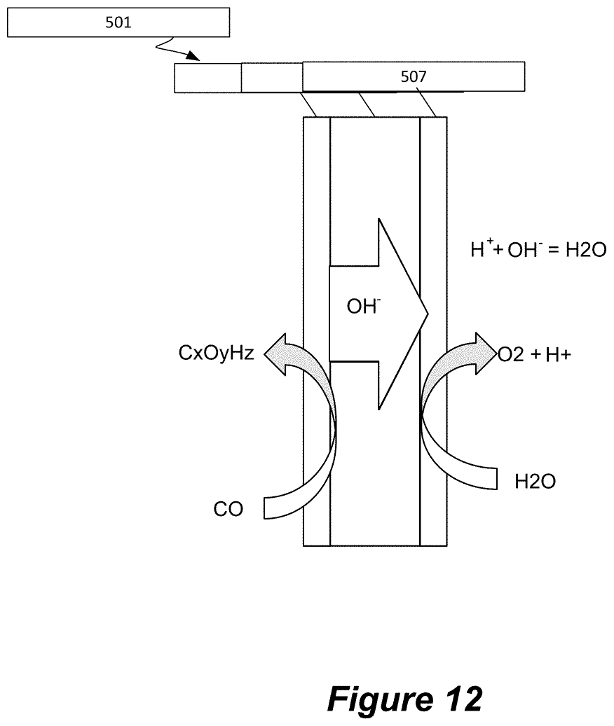

In the below examples, reference is made to MEAs including bipolar membrane MEAs and MEAs that include only an anion exchange membrane or only a cation exchange membrane. Further details of MEAs are included below. In particular embodiments, MEAs with bipolar membranes and those with anion exchange membranes (AEMs) may be used. Examples of MEAs for methane and ethylene are provided below with additional description of MEAs for these and other products below. In particular, bipolar membrane MEAs are discussed with reference to FIGS. 9 and 10 and AEM-only MEAs are discussed with reference to FIGS. 11 and 12. Further description may be found in U.S. patent application Ser. No. 17/247,036, filed Nov. 24, 2020, incorporated by reference herein for its description of MEAs.

In a first example, a bipolar membrane MEA for the production of methane can include a gas distribution layer (GDL), a cathode catalyst layer, a bipolar membrane, and an anode catalyst layer as follows:
GDL:
   Sigracet 39BC (5% PTFE-treated microporous layer on carbon fiber, 0.325 mm-thick)
Catalyst Layer:
   0.16 mg/cm² of 20 nm 40% Premetek Cu/Vulcan XC-72 (360-410 nm particle size)
   19 wt. % anion-exchange polymer electrolyte (FumaTech FAA-3)
   1-2 μm catalyst layer thickness
Membrane:
   10-12 μm-thick anion-exchange (AEM) polymer electrolyte on Nafion (PFSA) 212 (50.8 μm thickness) Proanode (Fuel Cell Etc) membrane
Anode:
   3 mg/cm² IrRuOx anode

In another example, a bipolar membrane MEA for the production of methane can include a GDL, a cathode catalyst layer, a bipolar membrane, and an anode catalyst layer as follows:
GDL:
   Single or multiple, stacked 5-20% PTFE-treated microporous layer-coated carbon fiber substrate(s) (SGL Carbon, Freudenberg Performance Materials, AvCarb Material Solutions, or other GDL manufacturers, 0.25-0.5 mm thick)
Catalyst Layer:
   0.1-3.0 mg/cm2 of 20-100 nm Cu nanoparticles supported on carbon, for example, Premetek Cu/Vulcan XC-72 (20%-60% Cu loading)
   5-50 wt. % anion exchange polymer electrolyte (Fumatech BWT GmbH, Ionomr Innovations Inc, or other anion exchange polymer electrolyte manufacturers)
   1-5 μm catalyst layer thickness
Membrane:
   5-20 μm-thick anion exchange polymer electrolyte on cation exchange membrane such as Nafion® membranes (25-254 μm thickness)
Anode:
   0.5-3 mg/cm2 IrRuOx or IrOx anode catalyst layer and porous Ti gas diffusion layer

In another example, a bipolar MEA for the production of ethylene can include a GDL, a cathode catalyst layer, a bipolar membrane, and an anode catalyst layer as follows:
GDL:
   Sigracet 39BC (5% PTFE-treated microporous layer on carbon fiber, 0.325 mm-thick)
Catalyst Layer:
   0.35 mg/cm2 of 100% Sigma Aldrich Cu (80 nm particle size)
   19 wt. % anion-exchange polymer electrolyte (FumaTech FAA-3)
   2-3 μm thickness
Membrane:
   20-24 μm-thick AEM polymer electrolyte on Nafion (PFSA) 115 (50.8 um thickness) Proanode (Fuel Cell Etc) membrane
Anode:
   3 mg/cm2 IrRuOx anode

In another example, a bipolar MEA for the production of ethylene can include a gas distribution layer (GDL), a cathode catalyst layer, a bipolar membrane, and an anode catalyst layer as follows:
GDL:
   Single or multiple, stacked 5-20% PTFE-treated microporous layer-coated carbon fiber substrate(s) (SGL Carbon, Freudenberg Performance Materials, AvCarb Material Solutions, or other GDL manufacturers, 0.25-0.5 mm thick)
Catalyst Layer:
   0.1-3.0 mg/cm² of pure Cu nanoparticles or Cu-based alloy nanoparticles (5-150 nm particle size) deposited via ultrasonic spray deposition, e-beam evaporation, magnetron-sputtering, or other analogous coating process
   5-50 wt. % anion exchange polymer electrolyte (Fumatech BWT GmbH, Ionomr Innovations Inc, or other anion exchange polymer electrolyte manufacturers)
   1-5 μm catalyst layer thickness
Membrane:
   5-20 μm-thick anion-exchange (AEM) polymer electrolyte (Fumatech BWT GmbH, Ionomr Innovations Inc, or other anion exchange polymer electrolyte manufacturers) on cation exchange membrane such as Nafion® membranes (25-254 μm thickness)
Anode:
   0.5-3 mg/cm2 IrRuOx or IrOx anode catalyst layer and porous Ti gas diffusion layer

In another example, an AEM-only MEA for the production of ethylene can include a GDL, a cathode catalyst layer, an anion-exchange membrane, and an anode catalyst layer as follows:
GDL:
   Sigracet 39BC (5% PTFE treated microporous layer on carbon fiber, 0.325 mm-thick)
Catalyst Layer sprayed on GDL:
   0.35 mg/cm2 of 100% Sigma Aldrich Cu (80 nm particle size)
   19 wt. % anion-exchange polymer electrolyte (FumaTech FAA-3)
   2-3 μm thickness
Membrane:
   KOH-exchanged Ionomr AF1-HNN8-50-X AEM
   50 μm thickness, >80 mS/cm conductivity, 33-37% water uptake
Anode:
   IrOx-coated porous Ti (Proton Onsite)

In another example, an AEM-only MEA for the production of ethylene can include a GDL, a cathode catalyst layer, an anion-exchange membrane, and an anode catalyst layer as follows:
GDL:
   Single or multiple, stacked 5-20% PTFE-treated microporous layer-coated carbon fiber substrate(s) (SGL Carbon, Freudenberg Performance Materials, AvCarb Material Solutions, or other GDL manufacturer, 0.25-0.5 mm thick)
Catalyst Layer coated on GDL:
   0.1-3.0 mg/cm2 of pure Cu nanoparticles or Cu-based alloys (25-100 nm particle size) deposited via ultrasonic spray deposition, e-beam evaporation, magnetron-sputtering, or other analogous coating process
   5-50 wt. % anion exchange or cation exchange polymer electrolyte (Fumatech BWT GmbH, Ionomr Innovations Inc, or other anion/cation exchange polymer electrolyte manufacturers)
   1-5 μm thickness
Membrane:
   KOH-exchanged anion exchange polymer membrane (Fumatech BWT GmbH, Ionomr Innovations Inc, or other anion-exchange polymer membrane manufacturers)
   15-75 μm thickness, >60 mS/cm conductivity, 20-100% water uptake
Anode:
   IrOx-coated porous Ti

The cathode catalyst layer of the MEA includes a catalyst configured for production of ethylene or other desired product. A catalyst configured for ethylene has a propensity to catalyze one or more methane production reactions preferentially over other reactions. Suitable catalysts include transition metals such as copper (Cu). According to various embodiments, the catalyst may be doped or undoped Cu or an alloy thereof. An MEA cathode catalyst described as containing copper or other transition metal is understood to include alloys, doped metals, and other variants of copper or other transition metals. In general, the catalysts described herein for hydrocarbon and oxygen-containing organic products are non-noble metal catalysts. Gold (Au), for example, may be used to catalyze carbon monoxide (CO) production. The conformation of the catalyst layer may be engineered to achieve a desired methane (or other desired product) production characteristics for the MEA. Conformation characteristics such as thickness, catalyst loading, and catalyst roughness can affect desired product production rate, desired production selectivity (e.g., selectivity of methane over other potential products, such as hydrogen, ethylene, etc.), and/or any other suitable characteristics of carbon dioxide reactor operation.

Examples of cathode catalyst layers for multi-electron products such as ethylene are given above. Further examples and examples of cathode catalyst layers for CO production include:
CO production: Au nanoparticles 4 nm in diameter supported on Vulcan XC72R carbon and mixed with TM1 anion exchange polymer electrolyte from Orion. Layer is about 15 μm thick, Au/(Au+C)=30%, TM1 to catalyst mass ratio of 0.32, mass loading of 1.4-1.6 mg/cm², estimated porosity of 0.47
Methane production: Cu nanoparticles of 20-30 nm size supported on Vulcan XC72R carbon, mixed with FAA-3 anion exchange solid polymer electrolyte from Fumatech. FAA-3 to catalyst mass ratio of 0.18. Estimated Cu nanoparticle loading of ˜7.1 μg/cm², within a wider range of 1-100 μg/cm².
Ethylene/ethanol production: Cu nanoparticles of 25-80 nm size, mixed with FAA-3 anion exchange solid polymer electrolyte from Fumatech. FAA-3 to catalyst mass ratio of 0.10. Deposited either on Sigracet 39BC GDE for pure AEM or onto the polymer-electrolyte membrane. Estimated Cu nanoparticle loading of 270 μg/cm².
Bipolar MEA for methane production: The catalyst ink is made up of 20 nm Cu nanoparticles supported by Vulcan carbon (Premetek 40% Cu/Vulcan XC-72) mixed with FAA-3 anion exchange solid polymer electrolyte (Fumatech), FAA-3 to catalyst mass ratio of 0.18. The cathode is formed by the ultrasonic spray deposition of the catalyst ink onto a bipolar membrane including FAA-3 anion exchange solid polymer electrolyte spray-coated on Nafion (PFSA) 212 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
Bipolar MEA for ethylene production: The catalyst ink is made up of pure 80 nm Cu nanoparticles (Sigma Aldrich) mixed with FAA-3 anion exchange solid polymer electrolyte (Fumatech), FAA-3 to catalyst mass ratio of 0.09. The cathode is formed by the ultrasonic spray deposition of the catalyst ink onto a bipolar membrane including FAA-3 anion exchange solid polymer electrolyte spray-coated on Nafion (PFSA) 115 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
CO production: Au nanoparticles 4 nm in diameter supported on Vulcan XC72R carbon and mixed with TM1 anion exchange polymer electrolyte from Orion. Layer is about 14 micron thick, Au/(Au+C)=20%. TM1 to catalyst mass ratio of 0.32, mass loading of 1.4-1.6 mg/cm², estimated porosity of 0.54 in the catalyst layer.
CO production: Au nanoparticles 45 nm in diameter supported on Vulcan XC72R carbon and mixed with TM1 anion exchange polymer electrolyte from Orion. Layer is about 11 micron thick, Au/(Au+C)=60%. TM1 to catalyst mass ratio of 0.16, mass loading of 1.1-1.5 mg/cm², estimated porosity of 0.41 in the catalyst layer.
CO production: Au nanoparticles 4 nm in diameter supported on Vulcan XC72R carbon and mixed with TM1 anion exchange polymer electrolyte from Orion. Layer is about 25 micron thick, Au/(Au+C)=20%. TM1 to catalyst mass ratio of 0.32, mass loading of 1.4-1.6 mg/cm², estimated porosity of 0.54 in the catalyst layer.

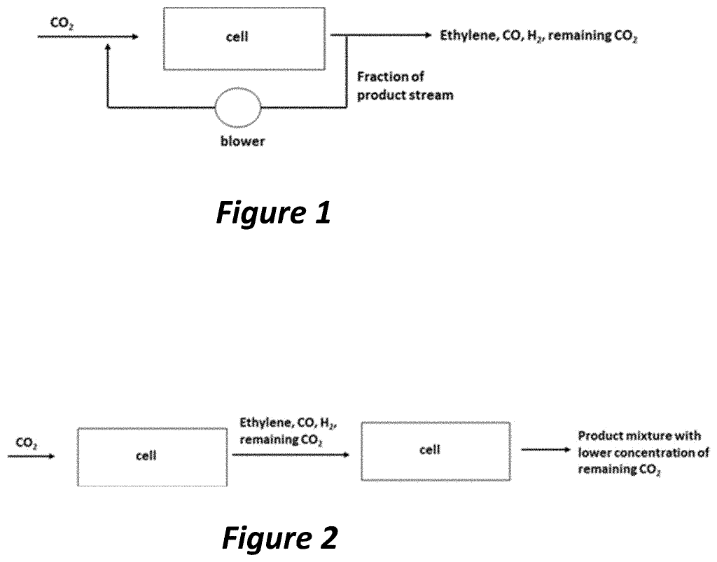

The above MEAS examples may be implemented in the COₓ reduction electrolyzers described below that are configured to increase concentration of a desired product in a product stream. First, in FIG. 1, an system with electrochemical cell and a recycle loop is shown. In the example of FIG. 1, the cell is configured to produce ethylene. The input of the cell includes a combination of the output from the previous pass and fresh CO₂. This system uses a lower CO₂ input flow than for a single-pass system, since a fraction of the reactant is gas that has been recycled through the system. The output is a mixture of ethylene, CO and H₂, as well as unreacted CO₂. CO₂ concentration is lower than that compared to a single-pass system, with the ratio of products:CO₂ dependent upon how much of the gas is recycled.

A recycling blower or other compressor may be used to help regulate the flow of gas into the system, and to compensate for pressure drop across the reactor. In the example of FIG. 1, the unreacted CO₂ is not separated from the output stream for recycle. As described above, the formation of ethylene uses a relatively small amount of input CO₂. Notably, the recycling of ethylene and other products along with unreacted CO₂ can help increase flow rate while limiting the amount of CO₂ input into the cell. Ethylene pressure in the recycle stream can help with maintaining a minimum flow rate to regulate water, pH, and other environmental conditions.

For 100 cm² cells, flow rates of at least 300 sccm, at least 450 sccm, or at least 700 sccm, with a maximum flow rate of 6000 sccm, through the cell may be used to maintain selectivity for ethylene. The ratio of new CO₂ to recycled gas depends upon the rate of the blower.

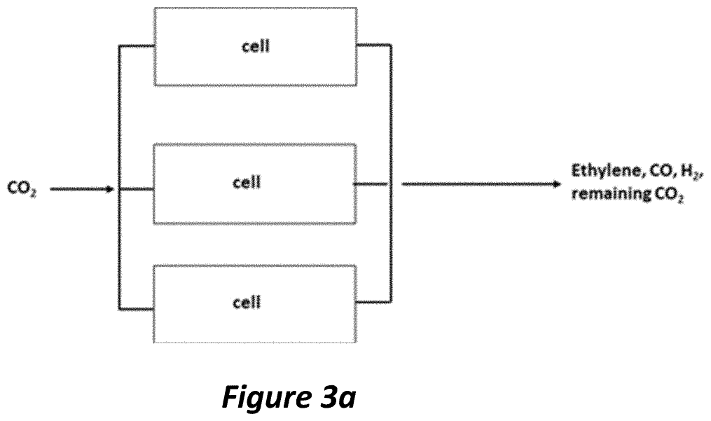

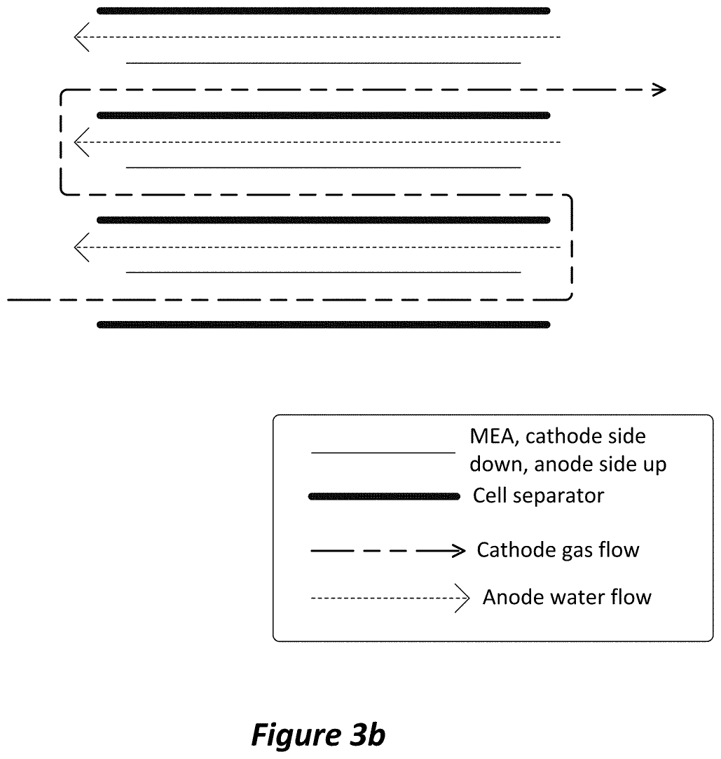

In the example of FIG. 1 (and FIGS. 2 and 3a discussed below), CO₂ is shown as the starting reactant. In other embodiments, CO or a mixture of CO and CO₂ may be used as the starting reactant. Also, in other embodiments the electrolyzer may be configured to produce another gas phase multielectron product such as methane, ethane, propane, or propylene. Further, in some embodiments, a recycle loop as described with respect to FIG. 1 may be implemented for CO production. In embodiments in which CO₂ is the starting reactant, the MEA may have a bipolar membrane or a cation exchange membrane to allow for recycle of CO₂ in the product stream. As discussed further below, CO₂ in electrolyzers with AEM-only MEAs is transported to the anode-side of the electrolyzer.

In some embodiments, a system may include a purification unit downstream of the recycle loop to remove the remaining CO₂ and H₂ in the product stream. Purification units are described in U.S. Provisional Patent Application No. 63/060,583, incorporated by reference herein.

In some embodiments, the unreacted CO₂ may be first separated from the product stream prior to recycling.

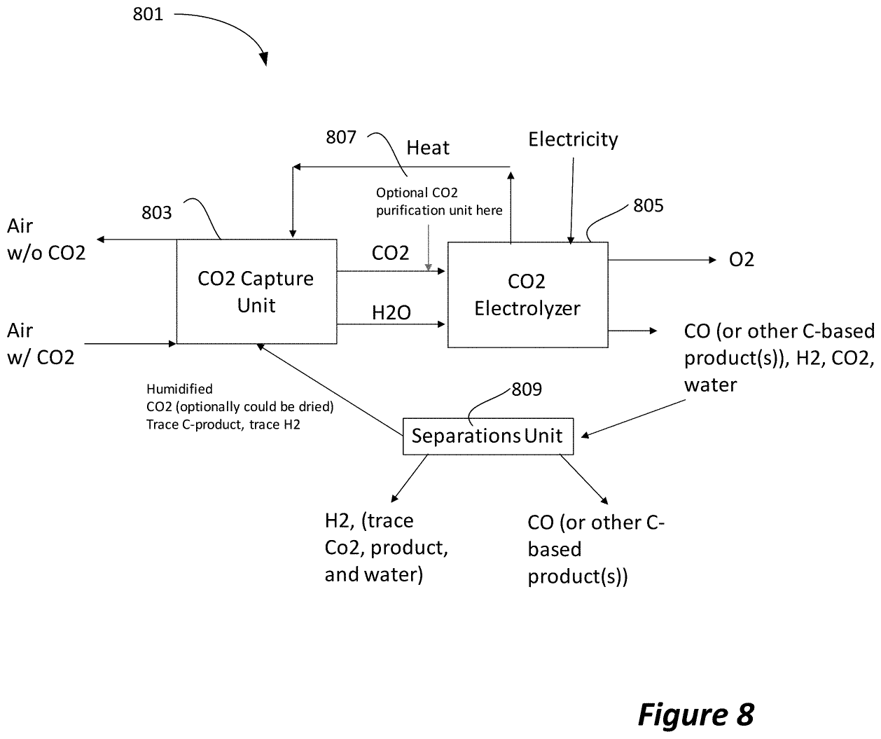

In some embodiments, a direct air capture unit is provided upstream of the cell in FIG. 1 to supply CO₂ to the cell. Systems including direct air capture units are described further below with reference to FIG. 8. FIG. 2 shows another configuration in which multiple electrochemical cells in series are used to increase product concentration. In the example of FIG. 2, two cells are shown, however, three, four, or more cells may be used in series. By feeding the output of a first electrochemical cell as the inlet to a second, third . . . nth cell, the concentration of CO₂ will decrease, and concentration of products increase with each consecutive cell. The product concentration after the second cell in the series may be roughly estimated by taking the CO₂ from the output of the first cell and using the current efficiency to determine the conversion. The output of two cells in series will have twice the product concentration as after the first cell and so on for additional cells in series.

Comparative Example 1 shows total CO₂ utilization and output gas stream composition for two cells as in Example 1 in series. Table 4 compares the CO₂ utilization and output gas stream composition of Example 1 with Comparative Example 1.

TABLE 4
Single CO₂ cell compared with two CO₂ cells
in series for CH₄ production

| | Example 1: | Comparative Example 1- |
|---|---|---|
| | single cell | cells in series |
| | CH₄ production | CH₄ production |
| Input CO₂ flow into | 450 sccm | 450 sccm |
| cell 1 | | |
| Input CO₂ flow into | NA | 492 sccm |
| cell 2 | | |
| Current efficiency | 90% for CH₄ | 90% for CH₄ |
| cell 1 | 10% for H₂ | 10% for H₂ |
| Current efficiency | NA | 90% for CH₄ |
| cell 2 | | 10% for H₂ |
| Total CO₂ utilization | 21% | 42% |
| Output gas stream | 72.3% CO₂ | 48.9% CO₂ |
| | 19.2% CH₄ | 35.4% CH₄ |
| | 8.5% H₂ | 15.7% H₂ |
| Output gas flow rate | 492 sccm | 534 sccm |

Putting cells from Example 1 above in series results in a first cell of 100 cm² at 600 mA/cm² with CO₂ utilization of 21%, and an output gas stream composition of 19.2% methane, 8.5% H₂, and 72.3% CO₂ with a total flow rate of 492 sccm. The output of this first cell is then fed to a second cell also of 100 cm² area with 90% current efficiency for methane and 10% current efficiency for H₂ which results in a product stream from the second cell of 534 sccm total flow composed of 35.4% methane, 15.7% H₂, and 48.9% CO₂. The combined CO₂ utilization of both cells together is 42%. Additional cells in series further increases the concentration of methane and H₂ and decreases the concentration of CO₂, within the limit that CO₂ concentration does not go below zero, at which point the methane current efficiency will also drop to zero and the H₂ current efficiency will rise to 100%.

Putting cells from Example 3 above in series has a similar effect as shown in Table 5.

TABLE 5
Single CO₂ cell compared with CO₂ cells
in series for CH₂CH₂ production

| | | Comparative |
|---|---|---|
| | Example 3: | Example 2- |
| | single cell CH₂CH₂ | cells in series |
| | production | CH₂CH₂ production |
| Input CO₂ flow into | 450 sccm | 450 sccm |
| cell 1 | | |
| Input CO₂ flow into | NA | 429 sccm |
| cell 2 | | |
| Current efficiency | 90% for CH₂CH₂ | 90% for CH₂CH₂ |
| cell 1 | 10% for H₂ | 10% for H₂ |
| Current efficiency | NA | 90% for CH₂CH₂ |
| cell 2 | | 10% for H₂ |
| Total CO₂ utilization | 28% | 56% |
| Output gas stream | 78.7% CO₂ | 48.6% CO₂ |
| | 12.8% CH₂CH₂ | 30.9% CH₂CH₂ |
| | 8.5% H₂ | 20.6% H₂ |
| Output gas flow rate | 429 sccm | 408 sccm |

With multiple cells in series, the initial COₓ flow rate is high to help with water management, with the multiple cells used to convert much of the COₓ. The examples show how the total gas flow rate can change (increase or decrease) between cells. If the total gas flow rate decreases below a critical level needed to prevent flooding, then additional gas can be added to the stream between cells to bring the total above the desired level. This additional gas could come from recycling the output of the system (as described with respect to FIG. 1) or it could be introduced from another source and could be comprised of CO₂, ethylene, H₂, etc. For implementations in which the gas flow increases between cells, in some embodiments, part of the gas stream may bypass downstream cells to maintain flow in the desired range.

According to various embodiments, between 300 sccm and 6000 sccm flow through a 100 cm² cell can be useful to maintain selectivity for ethylene and other many electron CO₂ reduction products (e.g. methane). In some embodiments, this may be between 450 sccm and 6000 sccm or 700 sccm and 6000 sccm. A flow rate of 3-60 sccm/cm², or 4.5-60 sccm/cm², or 7-60 sccm/cm² may be used for other sized cells.

In addition to flow rate adjustments, pressure and water content of the gas stream may be changed between cells. Water can be added to the stream with a humidifier or removed through phase separators, cooling the gas stream, and/or adsorbents. Pressure can be increased by a compressor between cells. In some embodiments, multiple cells in series are provided in a compact stack of cells as described below with respect to FIG. 3b.

In other embodiments, CO may be used as the starting reactant and/or the electrolyzer may be configured to produce another gas phase multielectron product such as methane, ethane, propane, or propylene. Further, in some embodiments, multiple cells in series may be used to concentrate CO as the desired product.

Any of the cells described herein may be one of a stack of cells. FIG. 3a shows multiple electrochemical cells stacked in parallel with a single CO₂ flow stream shared between the cells. This allows more efficient scale-up of the amount of product generated. The final concentration of ethylene is the same as for a single-pass cell, but the total volume of ethylene generated is increased with the addition of each cell. A recycle loop as described with respect to FIG. 1 could be implemented for individual cells in a stack and/or between stacks of cells.

FIG. 3b shows multiple electrochemical cells arranged in a stacked and connected in series as described above with respect to FIG. 2. An MEA may be placed in the stack with the anode up and the cathode down (as in FIG. 3b) or the anode down and the cathode up, or in a vertical configuration.

An arrangement as in FIG. 3b can be used to achieve high CO or CO₂ utilization while maintaining a high gas flow rate through the cell to efficiently remove water. The design is more compact than unstacked cells connected in series and the balance of plant, such as power electronics flow controllers, temperature controllers, pressure controllers, etc. is simplified by only having one cell stack instead of multiple separate cells that each use their own controller. In the example of FIG. 3b, a 3-cell stack is shown. Stacks may have ones, tens, or hundreds of cells, according to various embodiments. In some embodiments, a whole stack is in series. In other embodiments, subsets of cells are in series and connected to other subsets in parallel. For example, in a 100 cell stack, the input cathode gas flow could run in series through every 10, 5, 3, or 2 cells and each block of cells plumbed in series put in parallel.

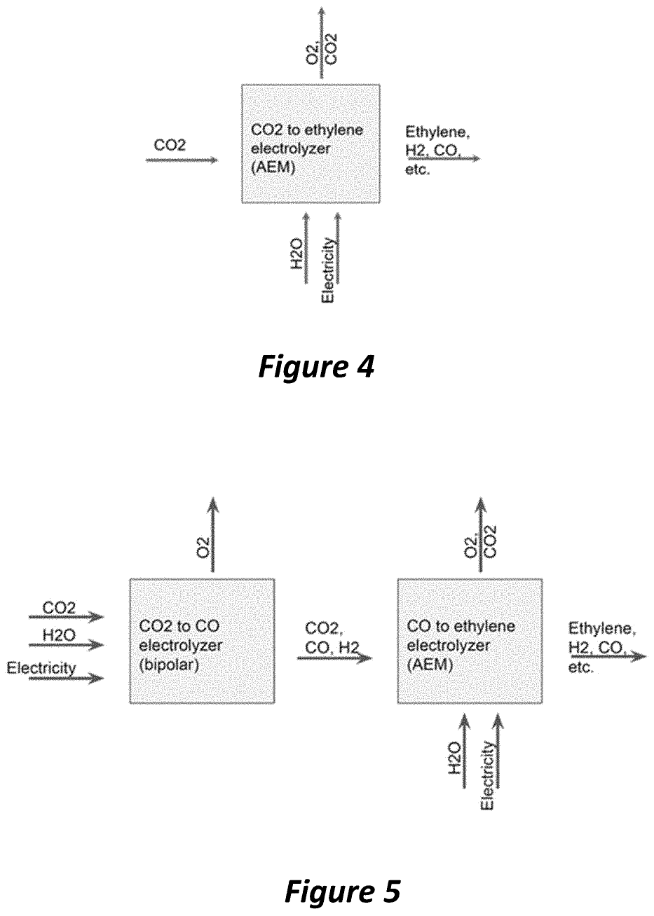

In some embodiments, a carbon oxide reduction electrolyzer includes an MEA with only an anion exchange membrane (AEM). The AEM-only MEA can be used to remove CO₂ from the product gas stream to achieve a higher concentration of the desired product in the electrolyzer output. CO₂ reacts with hydroxide generated in the COₓ reduction reaction to make bicarbonate. Bicarbonate is then transported through the anion-exchange membrane from the cathode to the anode side. This results in less CO₂ in the cathode output and higher concentration of COₓ reduction products such as methane and ethylene. In some embodiments, the cathode output may have substantially no CO₂. The amount of CO₂ can depend on the initial starting CO₂. According to various embodiments, the cathode output may be less than 5 mole %, less than 1 mole %, or less than 0.1 mole %. FIG. 4 shows an example of a single stage CO₂ reduction electrolyzer with an AEM-only MEA. As can be seen, on the anode-side, CO₂ is mixed with O₂. The product stream includes ethylene, H₂, and CO.

In the example of FIG. 4, water is fed to the anode of an electrolyzer and is oxidized to oxygen. H₂ may be an anode-side feedstock in some embodiments. In some embodiments, carbon-containing anode feedstocks are used. These may be especially advantageous when performing CO₂ reduction in an AEM based electrolyzer. A liquid or gas feedstock containing carbon compounds is fed to the anode. The carbon compound is oxidized to make CO₂ resulting a stream of pure CO₂ coming from the anode of the AEM electrolyzer. According to various embodiments, the CO₂ may then be fed back into the cathode of the COₓ electrolyzer, used in other applications, or sequestered. Examples of anode feedstocks are biogas, natural gas, CO₂ separated from biogas that contains trace methane and/or other hydrocarbons, municipal wastewater, alcohol or aqueous alcohol solutions, steam methane reforming waste streams, carbon monoxide, etc.

In embodiments in which water is used to feed the anode of the electrolyzer and oxidized to oxygen gas as shown in FIG. 4, the anode-side gas phase output stream of the electrolyzer contains oxygen and CO₂. In some embodiments, a gas separator can be used to separate the CO₂ and O₂ with the CO₂ stream recycled back to the inlet of the electrolyzer to be reduced.

In a specific example, in a 100 cm² electrochemical cell at 600 mA/cm² with 90% current efficiency for ethylene and 10% current efficiency for H₂ at the input flow rate of 450 sccm, the cathode output stream has a flow rate of 104 sccm and contains approximately 60% ethylene and 40% hydrogen with only trace CO₂, with most of the unreacted CO₂ traveling to the anode side of the device.

In some embodiments, input flow rates of up to 900 sccm for a 100 cm² electrolyzer may be used without appreciable concentrations of CO₂ appearing in the cathode gas product stream. With an input flow rate of 910 sccm, the output stream contains 56% ethylene, 37.3% H₂, and 6.7% CO₂ and has a total flow rate of 113 sccm.

In other embodiments, the electrolyzer may be configured to produce another gas phase multielectron product such as methane, ethane, propane, or propylene. Further, in some embodiments, an AEM-only MEA may be implemented for CO production.

In some embodiments, two electrolyzers in series are configured differently to achieve a high concentration of product in the outlet stream. This may also result in performance improvements of the combined system over a single device. FIG. 5 shows another embodiment in which the AEM-only membrane is implemented in a such a two-stage system. In the example of FIG. 5, a first CO₂ electrolyzer may contain a bipolar or cation conducting membrane and be configured for CO production. An input of CO₂ to the cathode is reduced to CO. The reactor output then contains CO, a small amount of byproduct H₂, and unreacted CO₂. This output of the first electrolyzer is then fed to a second electrolyzer configured to produce ethylene and/or other many electron product(s) (e.g. methane, ethylene, etc.) and containing an AEM membrane. In the second electrolyzer, the CO and/or CO₂ is reduced to a many electron product and CO₂ in the form of carbonate or bicarbonate moves across the AEM membrane to the anode. The anode output contains the oxidation product and CO₂ that originally came from the cathode. The cathode output contains ethylene and/or other many electron product(s), hydrogen, and unreacted CO and CO₂. The CO₂ concentration may be very low or no CO₂ may be left in the stream because all or a large part of the CO₂ has been transported to the anode.

In a specific example, the first electrolyzer is a 75 cm² single cell configured for CO₂ to CO reduction using a bipolar membrane-based MEA. The input flow rate is 1500 sccm, the CO current efficiency is greater than 95% and the H₂ current efficiency is less than 5%. The output flow total is approximately 1515 sccm with a composition of approximately 15% CO, 1% H₂, and 84% CO₂. The output from the first electrolyzer is fed to a second electrolyzer configured for ethylene production containing an AEM based MEA. The second electrolyzer is 100 cm² and operating at 600 mA/cm² with a current efficiency of 90% ethylene and 10% H₂. The cathode outlet stream from the second electrolyzer contains 15.6% ethylene, 6.3% CO, 6.9% H₂, and 71.2% CO₂ and a total flow of 606 sccm total.

The reduction of CO is often kinetically easier than the reduction of other COₓ species, so the second electrolyzer, which takes a combined CO and CO₂ feedstock, may operate at a lower voltage compared to the case where it is fed CO₂, carbonate and/or bicarbonate.

Between the first and second electrolyzer, additional gas may be added or removed from the stream and may be part of recycle loops going to and from other parts of the electrolyzer. Water may be removed or added to the gas stream via humidification, phase separation, or dehumidification. The pressure of the gas stream may be adjusted up or down using compressors or back flow regulators.

A two-stage system as described in FIG. 5 may also be used for CO production, with the AEM-only MEA configured for CO production rather than ethylene or other many electron product. In such embodiments, the first (bipolar) electrolyzer an output of product CO, unreacted CO₂, and byproduct H₂. This may all be fed to the second (AEM) electrolyzer, which will make CO and H₂. According to various embodiments, the output of the second electrolyzer may have more H₂ than CO or more CO than H₂. CO₂ will be removed from the stream in the AEM electrolyzer, so the product output will be CO+H₂, with most of the CO₂ removed.

According to various embodiments, the output of the second electrolyzer may be less than 30%, less than 5%, less than 1%, or less than 0.1% by mole CO₂.

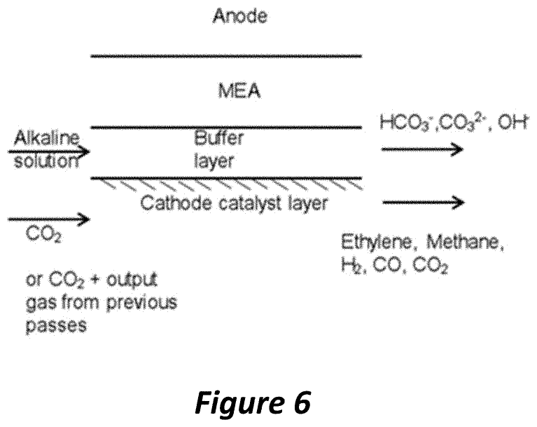

FIG. 6 shows an example of an electrolyzer that includes a buffer layer of an aqueous alkaline solution provided between the membrane and the cathode. Examples of solutions include KOH, NaOH, NaHCO₃, and KHCO₃ solutions. Cesium-containing solutions may also be used. The buffer layer removes CO₂ from the product gas stream and mitigates H₂ production by providing an alkaline environment to decrease proton activity. CO₂ reacts with OH⁻ in the buffer layer to make bicarbonate. Bicarbonate is then transported through the anion-exchange membrane from the cathode to the anode side or transported out of the cathode side by flowing the liquid in the buffer layer. This results in less CO₂ in the cathode output. The buffer layer also helps to maintain high pH at the cathode and suppress H₂ production. Since H₂ is the product of a 2-electron process, the suppression of H₂ production will lead to the increase of COx reduction products (e.g., methane, ethylene). In some embodiments, AEM-only MEAs or bipolar membrane MEAs are used.

A cell including a liquid buffer as described above can be set up as a single cell or multiple cells with a single pass or multiple passes as described above with respect to FIGS. 1-3b. The gaseous input of the electrochemical cell includes pure CO₂ for a single pass or a combination of the output from the previous pass and fresh CO₂ for multiple passes. As described above, a multiple pass system uses a lower CO₂ input flow than for a single-pass system, since a fraction of the reactant is gas that has been recycled through the system. The cathode liquid input includes the alkaline solution, which can be in a single pass or circulated from the outlet of the buffer layer if there is enough OH⁻ available to capture CO₂. The gaseous output includes a mixture of COₓ reduction products, as well as a lower concentration of CO₂ and H₂ compared to a system without the alkaline buffer layer, with the ratio of products:CO₂ dependent upon the concentration of alkaline species in the buffer layer and the gas flow rate in the gas stream. The liquid output includes CO₃²⁻, HCO₃⁻ that are formed by the reaction of CO₂ and OH⁻, as well as extra OH⁻ that is not reacted.

### System

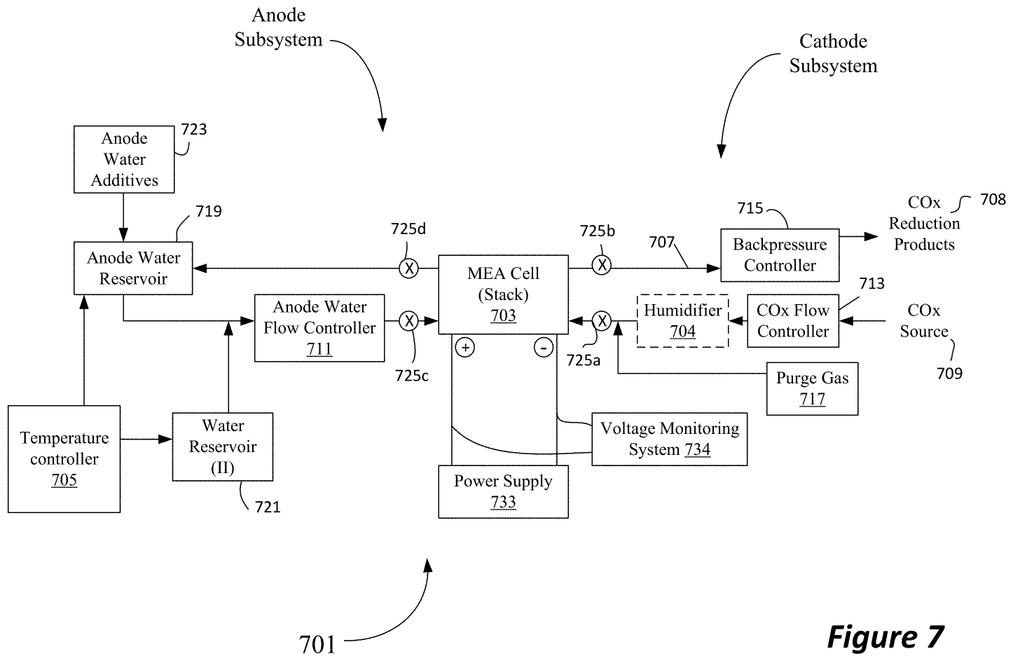

FIG. 7 depicts a system 701 for controlling the operation of a carbon oxide reduction reactor 703 that may include a cell including a MEA such as any one or more of those described herein with respect to FIGS. 1-6. The reactor may contain multiple cells or MEAs arranged in a stack. System 701 includes an anode subsystem that interfaces with an anode of reduction reactor 703 and a cathode subsystem that interfaces with a cathode of reduction reactor 703.

As depicted, the cathode subsystem includes a carbon oxide source 709 configured to provide a feed stream of carbon oxide to the cathode of reduction reactor 703, which, during operation, may generate an output stream that includes product(s) of a reduction reaction at the cathode. The product stream may also include unreacted carbon oxide and/or hydrogen. See 708.

The carbon oxide source 709 is coupled to a carbon oxide flow controller 713 configured to control the volumetric or mass flow rate of carbon oxide to reduction reactor 703. One or more other components may be disposed on a flow path from flow carbon oxide source 709 to the cathode of reduction reactor 703. For example, an optional humidifier 704 may be provided on the path and configured to humidify the carbon oxide feed stream. Humidified carbon oxide may moisten one or more polymer layers of an MEA and thereby avoid drying such layers. Another component that may be disposed on the flow path is a purge gas inlet coupled to a purge gas source 717. In certain embodiments, purge gas source 717 is configured to provide purge gas during periods when current is paused to the cell(s) of reduction reactor 703. In some implementations, flowing a purge gas over an MEA cathode facilitates recovery of catalyst activity and/or selectivity. This may be due, at least in part, to flushing certain reaction intermediates off catalyst active sites and/or remove water from the cathode. Examples of purge gases include carbon dioxide, carbon monoxide, hydrogen, nitrogen, argon, helium, oxygen, and mixtures of any two or more of these.

During operation, the output stream from the cathode flows via a conduit 707 that connects to a backpressure controller 715 configured to maintain pressure at the cathode side of the cell within a defined range (e.g., about 10 to 800 psig or 50 to 800 psig, depending on the system configuration). The output stream may provide the reaction products 108 to one or more components (not shown) for separation and/or concentration.

In certain embodiments, the cathode subsystem is configured to controllably recycle unreacted carbon oxide from the outlet stream back to the cathode of reduction reactor 703. In some implementations, the output stream is processed to remove reduction product(s) and/or hydrogen before recycling the carbon oxide. Depending upon the MEA configuration and operating parameters, the reduction product(s) may be carbon monoxide, hydrogen, hydrocarbons such as methane and/or ethylene, oxygen-containing organic compounds such as formic acid, acetic acid, and any combinations thereof. In certain embodiments, one or more components, not shown, for removing water from the product stream are disposed downstream form the cathode outlet. Examples of such components include a phase separator configured to remove liquid water from the product gas stream and/or a condenser configured to cool the product stream gas and thereby provide a dry gas to, e.g., a downstream process when needed. In some implementations, recycled carbon oxide may mix with fresh carbon oxide from source 709 upstream of the cathode.

As depicted in FIG. 7, an anode subsystem is configured to provide an anode feed stream to an anode side of the carbon oxide reduction reactor 703. In certain embodiments, the anode subsystem includes an anode water source, not shown, configured to provide fresh anode water to a recirculation loop that includes an anode water reservoir 719 and an anode water flow controller 711. The anode water flow controller 711 is configured to control the flow rate of anode water to or from the anode of reduction reactor 703. In the depicted embodiment, the anode water recirculation loop is coupled to components for adjusting the composition of the anode water. These may include a water reservoir 721 and/or an anode water additives source 723. Water reservoir 721 is configured to supply water having a composition that is different from that in anode water reservoir 719 (and circulating in the anode water recirculation loop). In one example, the water in water reservoir 721 is pure water that can dilute solutes or other components in the circulating anode water. Pure water may be conventional deionized water even ultrapure water having a resistivity of, e.g., at least about 15 MOhm-cm or over 18.0 MOhm-cm. Anode water additives source 723 is configured to supply solutes such as salts and/or other components to the circulating anode water.

During operation, the anode subsystem may provide water or other reactant to the anode of reactor 703, where it at least partially reacts to produce an oxidation product such as oxygen. The product along with unreacted anode feed material is provided in a reduction reactor outlet stream. Not shown in FIG. 7 is an optional separation component that may be provided on the path of the anode outlet stream and configured to concentrate or separate the oxidation product from the anode product stream.

Other control features may be included in system 701. For example, a temperature controller may be configured to heat and/or cool the carbon oxide reduction reactor 703 at appropriate points during its operation. In the depicted embodiment, a temperature controller 705 is configured to heat and/or cool anode water provided to the anode water recirculation loop. For example, the temperature controller 705 may include or be coupled to a heater and/or cooler that may heat or cool water in anode water reservoir 719 and/or water in reservoir 721. In some embodiments, system 701 includes a temperature controller configured to directly heat and/or cool a component other than an anode water component. Examples of such other components in the cell or stack and the carbon oxide flowing to the cathode.

Depending upon the phase of the electrochemical operation, including whether current is paused to carbon oxide reduction reactor 703, certain components of system 701 may operate to control non-electrical operations. For example, system 701 may be configured to adjust the flow rate of carbon oxide to the cathode and/or the flow rate of anode feed material to the anode of reactor 703. Components that may be controlled for this purpose may include carbon oxide flow controller 713 and anode water controller 711.

In addition, depending upon the phase of the electrochemical operation including whether current is paused, certain components of system 701 may operate to control the composition of the carbon oxide feed stream and/or the anode feed stream. For example, water reservoir 721 and/or anode water additives source 723 may be controlled to adjust the composition of the anode feed stream. In some cases, additives source 723 may be configured to adjust the concentration of one or more solutes such as one or more salts in an aqueous anode feed stream.

In some cases, a temperature controller such controller 705 is configured to adjust the temperature of one or more components of system 701 based on a phase of operation. For example, the temperature of cell 703 may be increased or decreased during break-in, a current pause in normal operation, and/or storage.

In some embodiments, a carbon oxide electrolytic reduction system is configured to facilitate removal of a reduction cell from other system components. This may be useful with the cell needs to be removed for storage, maintenance, refurbishment, etc. In the depicted embodiments, isolation valves 725a and 725b are configured to block fluidic communication of cell 703 to a source of carbon oxide to the cathode and backpressure controller 715, respectively. Additionally, isolation valves 725c and 725d are configured to block fluidic communication of cell 703 to anode water inlet and outlet, respectively.

The carbon oxide reduction reactor 703 may also operate under the control of one or more electrical power sources and associated controllers. See, block 733. Electrical power source and controller 733 may be programmed or otherwise configured to control current supplied to and/or to control voltage applied to the electrodes in reduction reactor 703. The current and/or voltage may be controlled to apply a current at a desired current density. A system operator or other responsible individual may act in conjunction with electrical power source and controller 133 to fully define profiles of current applied to reduction reactor 103.

In certain embodiments, the electrical power source and controller acts in concert with one or more other controllers or control mechanisms associated with other components of system 701. For example, electrical power source and controller 733 may act in concert with controllers for controlling the delivery of carbon oxide to the cathode, the delivery of anode water to the anode, the addition of pure water or additives to the anode water, and any combination of these features. In some implementations, one or more controllers are configured to control or operate in concert to control any combination of the following functions: applying current and/or voltage to reduction cell 703, controlling backpressure (e.g., via backpressure controller 115), supplying purge gas (e.g., using purge gas component 717), delivering carbon oxide (e.g., via carbon oxide flow controller 713), humidifying carbon oxide in a cathode feed stream (e.g., via humidifier 704), flow of anode water to and/or from the anode (e.g., via anode water flow controller 711), and anode water composition (e.g., via anode water source 105, pure water reservoir 721, and/or anode water additives component 723).

In the depicted embodiment, a voltage monitoring system 734 is employed to determine the voltage across an anode and cathode of an MEA cell or across any two electrodes of a cell stack, e.g., determining the voltage across all cells in a multi-cell stack.

An electrolytic carbon oxide reduction system such as that depicted in FIG. 9 may employ a control system that includes one or more controllers and one or more controllable components such as pumps, sensors, dispensers, valves, and power supplies. Examples of sensors include pressure sensors, temperature sensors, flow sensors, conductivity sensors, voltmeters, ammeters, electrolyte composition sensors including electrochemical instrumentation, chromatography systems, optical sensors such as absorbance measuring tools, and the like. Such sensors may be coupled to inlets and/or outlets of an MEA cell (e.g., in a flow field), in a reservoir for holding anode water, pure water, salt solution, etc., and/or other components of an electrolytic carbon oxide reduction system.

Among the various functions that may be controlled by one or more controllers are: applying current and/or voltage to a carbon oxide reduction cell, controlling backpressure on an outlet from a cathode on such cell, supplying purge gas to a cathode inlet, delivering carbon oxide to the cathode inlet, humidifying carbon oxide in a cathode feed stream, flowing anode water to and/or from the anode, and controller anode feed composition. Any one or more of these functions may have a dedicated controller for controlling its function alone. Any two or more of these functions may share a controller. In some embodiments, a hierarchy of controllers is employed, with at least one master controller providing instructions to two or more component controllers. For example, a system may comprise a master controller configured to provide high level control instructions to (i) a power supply to a carbon oxide reduction cell, (ii) a cathode feed stream flow controller, and (iii) an anode feed stream flow controller. For example, a programmable logic controller (PLC) may be used to control individual components of the system.

In certain embodiments, a control system is configured to apply current to a carbon oxide reduction cell comprising an MEA in accordance with a set current as described herein. In certain embodiments, a control system is configured to control the flow rate of one or more feed streams (e.g., a cathode feed stream such as a carbon oxide flow and an anode feed stream) in concert with a current schedule. In some embodiments, current and/or voltage may be regulated to be regularly paused as described in U.S. patent application Ser. No. 16/719,359, filed on Dec. 18, 2019, and incorporated by reference herein for all purposes.

In certain embodiments, a control system may maintain salt concentration at defined levels and/or recover and recirculate anode water. In certain embodiments, the salt concentration is adjusted in concert with a schedule of applied current pauses to an MEA cell. Under control of the control system, the system may, for example, (a) recirculate anode water flowing out of an anode, (b) adjust the composition and/or flow rate of anode water into the anode, (c) move water from cathode outflow back to anode water, and/or (d) adjust the composition and/or flow rate of water recovered from the cathode stream, before returning to the anode. Note that the (d) may account for carbon oxide reduction products in recovered water from the cathode. However, in some implementations, this need not be considered as some reduction products may subsequently oxidize to harmless products at the anode.

A controller may include any number of processors and/or memory devices. The controller may contain control logic such software or firmware and/or may execute instructions provided from another source. A controller may be integrated with electronics for controlling operation the electrolytic cell before, during, and after reducing a carbon oxide. The controller may control various components or subparts of one or multiple electrolytic carbon oxide reduction systems. The controller, depending on the processing requirements and/or the type of system, may be programmed to control any of the processes disclosed herein, such as delivery of gases, temperature settings (e.g., heating and/or cooling), pressure settings, power settings (e.g., electrical voltage and/or current delivered to electrodes of an MEA cell), liquid flow rate settings, fluid delivery settings, and closing of purified water and/or salt solution. These controlled processes may be connected to or interfaced with one or more systems that work in concert with the electrolytic carbon oxide reduction system.

In various embodiments, a controller comprises electronics having various integrated circuits, logic, memory, and/or software that receive instructions, issue instructions, control operations described herein. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a process on one or more components of an electrolytic carbon oxide reduction system. The operational parameters may, in some embodiments, be part of a recipe defined by process engineers to accomplish one or more processing steps during generation of a particular reduction product such as carbon monoxide, hydrocarbons, and/or other organic compounds.

The controller, in some implementations, may be a part of or coupled to a computer that is integrated with, coupled to the system, otherwise networked to the system, or a combination thereof. For example, the controller may utilize instructions stored remotely (e.g., in the “cloud”) and/or execute remotely. The computer may enable remote access to the system to monitor current progress of electrolysis operations, examine a history of past electrolysis operations, examine trends or performance metrics from a plurality of electrolysis operations, to change parameters of current processing, to set processing steps to follow a current processing, or to start a new process. In some examples, a remote computer (e.g. a server) can provide process recipes to a system over a network, which may include a local network or the internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations.

The controller may be distributed, such as by comprising one or more discrete controllers that are networked together and working towards a common purpose, such as applying current to an MEA cell and other process controls described herein. An example of a distributed control system for such purposes includes one or more processors on a system for electrolytically reducing a carbon oxide and one or more processors located remotely (such as at the platform level or as part of a remote computer) that combine to control a process.

In certain embodiments, an electrolytic carbon oxide reduction system is configured and controlled to avoid precipitating salt within an MEA. Precipitated salt can block channels and/or have other impacts that degrade an MEA cell's performance. In some cases, a cell may become too dry, e.g., at the cathode side, because dry gaseous reactant removes too much water from the MEA, particularly on the cathode side. This issue, which may cause salt precipitation, may be addressed by controlling the water partial pressure in the gas inlet stream (e.g., by humidifying the gaseous carbon oxide source gas). In some cases, a salt concentration in anode water is sufficiently high that it promotes salt precipitation in the MEA. This issue may be addressed by flushing the MEA with pure water during a current pause.

In certain embodiments, an electrolytic carbon dioxide reduction system as described herein uses carbon dioxide received directly from air. The system includes a direct air CO₂ capture subsystem and a carbon dioxide reduction electrolyzer subsystem. The system is configured so that CO₂ from the capture subsystem supplies CO₂, directly or indirectly, to the cathode side of the electrolyzer subsystem. The carbon dioxide reduction electrolyzer subsystem may include any of the carbon dioxide reduction reactors and systems described above.

The system may be designed so that air or other gas is provided under specified conditions to the CO₂ capture subsystem. In certain embodiments, fans, vacuum pumps, or simply wind are used to deliver air to the CO₂ capture subsystem.

In certain embodiments, the CO₂ capture subsystem comprises two stages: a first stage in which air is contacted with a sorbent that removes CO₂ from air (phase 1), and second stage in which heat, electricity, pressure, and/or humidity is applied to the sorbent to release CO₂ and/or water (phase 2). In some implementations, the CO₂ capture subsystem employs a solid or liquid absorbent or adsorbent to capture the CO₂ in phase 1. In various implementations, phase 1 is performed at ambient conditions or near ambient conditions. In phase 2, a temperature, electrical, pressure, and/or moisture swing is applied, causing the absorbed or adsorbed CO₂, and optionally water, to be released. Further description and examples of CO₂ capture sub-systems are described in U.S. Provisional Patent Application No. 63/060,583, incorporated by reference herein.

Depending on the configuration of the CO₂ capture subsystem and its operating conditions, it can produce CO₂ from air at a high concentration of, e.g., about 90 mole % or greater. In some cases, the CO₂ capture subsystem is configured to produce CO₂ at a relatively lower concentration, which is still sufficient for CO₂ reduction electrolyzers to operate.

As indicated, captured and subsequently released CO₂ is feedstock that is delivered directly or indirectly to the cathode side of the CO₂ reduction electrolyzer. In certain embodiments, water captured from the air is also used in the feedstock of the CO₂ electrolyzer.

In certain embodiments, an air capture CO₂ electrolysis system is configured to operate in a manner that delivers CO₂ from a direct air capture subsystem in a substantially pure stream of, e.g., about 99 mole % CO₂ or greater. In certain embodiments, the system is configured to operate using a lower concentration of CO₂ to the electrolyzer, e.g., about 98 mole % CO₂ or greater, or about 90 mole % CO₂ or greater, or even about 50 mole % CO₂ or greater. In some cases, quite low CO₂ concentrations are used as the feedstock. Such concentrations are still substantially greater than the atmospheric concentration of carbon dioxide, which is about 0.035 mole %. In certain embodiments, the system is configured to operate using a CO₂ concentration of about 5-15 mole %, which is mixed with air or another gas such as nitrogen.

In certain embodiments, the output of the CO₂ capture subsystem contains only CO₂ and other components in air such as nitrogen, oxygen, water, argon, or any combination. In all cases, the CO₂ is present at a concentration that is greater than its concentration in air. In certain embodiments, the output of the CO₂ capture subsystem contains no sulfur.

A direct air capture unit and CO₂ electrolyzer can be integrated in several ways depending on the type of air capture technology. Heat and mass transfer components may be integrated in the overall air capture CO₂ electrolysis system.

For example, in some designs, CO₂ reduction electrolyzer is configured to receive CO₂ from and provide heat and/or humidity to the direct air capture subsystem. The provided heat may release captured CO₂ during phase 2 of a direct air capture subsystem employing a temperature swing desorption mechanism. Humidified electrolyzer product gas can be used to release captured CO₂ during phase 2 of a direct air capture subsystem employing a moisture swing desorption mechanism.

In certain embodiments, the CO₂ electrolyzer is designed or configured to receive dilute CO₂ (e.g., no greater than about 50 mole % CO₂) as an input.

Direct air capture units can be designed with multiple sorbent vessels. To receive a continuous stream of CO₂ (and optionally water) from the air capture subsystem, at least two different vessels are operated to be at a different stage of sorption/desorption during operation of the overall air capture CO₂ electrolysis system. For instance, while one sorbent vessel is taking in air to capture CO₂, another may be heated to release CO₂, as each vessel continues through the sorption/desorption cycle, the sorption vessel that was taking in CO₂ will vent CO₂ and vice versa. The addition of many vessels at different points in the cycle can deliver a continuous stream of inputs to the CO₂ electrolyzer and accept a continuous stream of air containing CO₂ and moisture and/or heat and/or vacuum.

Direct air capture units can be sized to deliver the desired volume of CO₂ flow for a CO₂ electrolyzer. This may involve employing multiple sorbent-containing vessels. For example, a direct air capture subsystem may be configured to deliver 750 slpm CO₂. Such subsystem may couple to a 200-cell electrochemical stack composed of 1000 cm2 membrane-electrode assemblies operated at 300 mA/cm2 and 3 V/cell to produce 378 slpm CO and 42 slpm hydrogen given 90% CO₂ to CO current efficiency of the process. As described above, unreacted CO₂ at the outlet of the electrolyzer may be recycled to the inlet to increase carbon efficiency. Operated continuously, the combined air capture and electrolyzer unit may produce approximately 675 kg/day CO. In general, in some designs, an air capture CO₂ electrolyzer system is configured to output at least about 100 kg/day CO and/or other CO₂ reduction product(s). in some designs, an air capture CO₂ electrolyzer system is configured to output at least about 500 kg/day CO and/or other CO₂ reduction product(s).

In certain embodiments, systems employing a carbon oxide electrolyzer and optional optionally a direct air capture of carbon dioxide unit also include a module configured to capture water from air or an atmosphere. In some embodiments, the module configured to capture water form air utilize solar energy from photovoltaics and/or thermal solar along with hygroscopic material. In certain embodiments, the module configured to capture water is an ambient dehumidifier such as a hydropanel (available from, e.g., Zero Mass Water, Inc. of Scottsdale, Ariz.).

FIG. 8 illustrates an air capture CO₂ electrolyzer system 801 comprising a direct air CO₂ capture subsystem 803 and an CO₂ reduction electrolyzer subsystem 805. As illustrated direct air CO₂ capture subsystem 803 is configured to receive, during sorption phase 1, air containing CO₂ under, e.g., atmospheric conditions (about 0.035 mole % CO₂) optionally with humidity, and release air with most CO₂ removed and optionally with much humidity removed.

Direct air CO₂ capture subsystem 803 is configured to release, during phase 2, CO₂ and optionally water. At least the CO₂, and optionally the water, are provided as inputs to the CO₂ electrolyzer 805. The CO₂ released from direct air capture subsystem 803 during phase 2 is provided to the cathode side of electrolyzer 805. As depicted, an optional CO₂ purification unit 807 is interposed between direct air CO₂ capture subsystem 803 and electrolyzer 805. The water optionally provided by direct air CO₂ capture subsystem 803 may be directed to the cathode side (as humidity in the CO₂ feedstock) or anode side (as reactant) of electrolyzer 805.

In the depicted embodiment, electrolyzer 805 is configured to receive electricity (to drive the CO₂ reduction reaction and the anode oxidation reaction). Also, electrolyzer 805 is configured to provide excess heat from the electrolysis reaction to direct air CO₂ capture subsystem 703 and drive phase 2 (CO₂ release from the sorbent). CO₂ electrolyzer 805 is configured to output oxygen (the anode reaction product when water is the reactant) and one or more CO₂ reduction products, which may include CO and/or other carbon-based products as described above with respect to FIGS. 1-7. As depicted, system 801 is configured to provide the electrolyzer output to a separations unit 809, configured to separate CO and/or other carbon-based electrolysis products from hydrogen, CO₂, water, and/or other components. In the depicted embodiment, system 801 is configured to deliver humidified CO₂ from separations unit 809 to direct air CO₂ capture subsystem 803. Any of the carbon dioxide electrolyzers described herein with respect to FIGS. 1-7 may be located downstream from a direct air CO₂ capture subsystem as shown in FIG. 8.

### MEA Overview

The above description references MEAs including bipolar and AEM-only MEAs. Further description of MEAs that may be used with various embodiments of the systems and methods described herein, including cation-exchange membrane-only MEAs, are provided below.

In various embodiments, an MEA contains an anode layer, a cathode layer, electrolyte, and optionally one or more other layers. The layers may be solids and/or gels. The layers may include polymers such as ion-conducting polymers.

When in use, the cathode of an MEA promotes electrochemical reduction of COₓ by combining three inputs: CON, ions (e.g., protons) that chemically react with CON, and electrons. The reduction reaction may produce CO, hydrocarbons, and/or oxygen and hydrogen containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

The compositions and arrangements of layers in the MEA may promote high yield of a COₓ reduction products. To this end, the MEA may facilitate any one or more of the following conditions: (a) minimal parasitic reduction reactions (non-COₓ reduction reactions) at the cathode; (b) low loss of COₓ reactants at anode or elsewhere in the MEA; (c) maintain physical integrity of the MEA during the reaction (e.g., prevent delamination of the MEA layers); (d) prevent COₓ reduction product cross-over; (e) prevent oxidation production (e.g., O₂) cross-over; (f) maintain a suitable environment at the cathode for oxidation; (g) provide pathway for desired ions to travel between cathode and anode while blocking undesired ions; and (h) minimize voltage losses. As explained herein, the presence of salts or salt ions in the MEA can facilitate some of all of these conditions.

### COₓ Reduction Considerations

Polymer-based membrane assemblies such as MEAs have been used in various electrolytic systems such as water electrolyzers and in various galvanic systems such as fuel cells. However, COₓ reduction presents problems not encountered, or encountered to a lesser extent, in water electrolyzers and fuel cells.

For example, for many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large surface area by comparison to MEAs used for fuel cells in automotive applications. For example, MEAs for COₓ reduction may employ electrodes having surface areas (without considering pores and other nonplanar features) of at least about 500 cm².

COₓ reduction reactions may be implemented in operating environments that facilitate mass transport of particular reactant and product species, as well as to suppress parasitic reactions. Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

In some systems, the rate of a COₓ reduction reaction is limited by the availability of gaseous COₓ reactant at the cathode. By contrast, the rate of water electrolysis is not significantly limited by the availability of reactant: liquid water tends to be easily accessible to the cathode and anode, and electrolyzers can operate close to the highest current density possible.

### MEA Configurations

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication, which would produce a short circuit. The cathode layer includes a reduction catalyst and a first ion-conducting polymer. The cathode layer may also include an ion conductor and/or an electron conductor. The anode layer includes an oxidation catalyst and a second ion-conducting polymer. The anode layer may also include an ion conductor and/or an electron conductor. The PEM includes a third ion-conducting polymer.

In certain embodiments, the MEA has a cathode buffer layer between the cathode layer and the polymer electrolyte membrane. The cathode buffer includes a fourth ion-conducting polymer.

In certain embodiments, the MEA has an anode buffer layer between the anode layer and the polymer electrolyte membrane. The anode buffer includes a fifth ion-conducting polymer.

In connection with certain MEA designs, there are three available classes of ion-conducting polymers: anion-conductors, cation-conductors, and mixed cation-and-anion-conductors. In certain embodiments, at least two of the first, second, third, fourth, and fifth ion-conducting polymers are from different classes of ion-conducting polymers.

### Ion-Conducting Polymers for MEA Layers

The term “ion-conducting polymer” is used herein to describe a polymer electrolyte having greater than about 1 mS/cm specific conductivity for anions and/or cations. The term “anion-conductor” describes an ion-conducting polymer that conducts anions primarily (although there will still be some small amount of cation conduction) and has a transference number for anions greater than about 0.85 at around 100 micron thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at about 100 micron thickness. For an ion-conducting polymer that is described as conducting both anions and cations (a “cation-and-anion-conductor”), neither the anions nor the cations have a transference number greater than approximately 0.85 or less than approximately 0.15 at about 100 micron thickness. To say a material conducts ions (anions and/or cations) is to say that the material is an ion-conducting material or ionomer. Examples of ion-conducting polymers of each class are provided in the below Table 1.

Ion-Conducting Polymers

| | | Common | |
|---|---|---|---|
| Class | Description | Features | Examples |
| A. | Greater than | Positively | aminated tetramethyl |
| Anion- | approximately 1 | charged | polyphenylene; |
| conduct- | mS/cm specific | functional | poly(ethylene-co- |
| ing | conductivity for | groups | tetrafluoroethylene)- |
| | anions, which | are covalently | based quaternary |
| | have a trans- | bound to the | ammonium polymer; |
| | ference number | polymer | quaternized |
| | greater than | backbone | polysulfone |
| | approximately 0.85 | | |
| | at around 100 | | |
| | micron thickness | | |
| B. | Greater than | Salt is | polyethylene oxide; |
| Conducts | approximately 1 | soluble in | polyethylene glycol; |
| both | mS/cm conductivity | the polymer | poly(vinylidene |
| anions | for ions (including | and the | fluoride); |
| and | both cations and | salt ions can | polyurethane |
| cations | anions), which have | move through | |
| | a transference | the polymer | |
| | number | material | |
| | between | | |
| | approximately | | |
| | 0.15 and 0.85 at | | |
| | around 100 micron | | |
| | thickness | | |
| C. | Greater than | Negatively | perfluorosulfonic acid |
| Cation- | approximately 1 | charged | polytetrafluoroethylene |
| conduct- | mS/cm specific | functional | co-polymer; |
| ing | conductivity for | groups are | sulfonated poly(ether |
| | cations, which have | covalently | ketone); |
| | a transference | bound to | poly(styrene sulfonic |
| | number greater | the polymer | acid- co-maleic acid) |
| | than approximately | backbone | |
| | 0.85 at | | |
| | around 100 | | |
| | micron thickness | | |

Further examples of polymeric structures that can include an ionizable moiety or an ionic moiety and be used as ion-conducting polymers in the MEAs of the electrolyzers described herein are provided in U.S. patent application Ser. No. 17/247,036, filed Nov. 24, 2020, incorporated by reference herein. Charge conduction through the material can be controlled by the type and amount of charge (e.g., anionic and/or cationic charge on the polymeric structure) provided by the ionizable/ionic moieties. In addition, the composition can include a polymer, a homopolymer, a copolymer, a block copolymer, a polymeric blend, other polymer-based forms, or other useful combinations of repeating monomeric units. As described further in U.S. patent application Ser. No. 17/247,036, an ion conducting polymer layer may include one or more of crosslinks, linking moieties, and arylene groups according to various embodiments. In some embodiments, two or more ion conducting polymers (e.g., in two or more ion conducting polymer layers of the MEA) may be crosslinked.

### Bipolar MEA for COx Reduction

In certain embodiments, the MEA includes a bipolar interface with an anion-conducting polymer on the cathode side of the MEA and an interfacing cation-conducting polymer on the anode side of the MEA. In some implementations, the cathode contains a first catalyst and an anion-conducting polymer. In certain embodiments, the anode contains a second catalyst and a cation-conducting polymer. In some implementations, a cathode buffer layer, located between the cathode and polymer electrolyte membrane (PEM), contains an anion-conducting polymer. In some embodiments, an anode buffer layer, located between the anode and PEM, contains a cation-conducting polymer.

During operation, an MEA with a bipolar interface moves ions through a polymer-electrolyte, moves electrons through metal and/or carbon in the cathode and anode layers, and moves liquids and gas through pores in the layers.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas generation is decreased and the rate of CO or other product production and the overall efficiency of the process are increased.

Another reaction that may be avoided is reaction of carbonate or bicarbonate ions at the anode to produce CO₂. Aqueous carbonate or bicarbonate ions may be produced from CO₂ at the cathode. If such ions reach the anode, they may react with hydrogen ions to produce and release gaseous CO₂. The result is net movement of CO₂ from the cathode to the anode, where it does not react and is lost with oxidation products. To prevent the carbonate and bicarbonate ion produced at the cathode from reaching the anode, the anode and/or an anode buffer layer may include a cation-conducting polymer, which at least partially blocks the transport of negative ions such as bicarbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂ and CO₂ reduction products (e.g., bicarbonate) to the anode side of the cell.

An example MEA 200 for use in COₓ reduction is shown in FIG. 9. The MEA 900 has a cathode layer 920 and an anode layer 940 separated by an ion-conducting polymer layer 960 that provides a path for ions to travel between the cathode layer 920 and the anode layer 940. In certain embodiments, the cathode layer 920 includes an anion-conducting polymer and/or the anode layer 940 includes a cation-conducting polymer. In certain embodiments, the cathode layer and/or the anode layer of the MEA are porous. The pores may facilitate gas and/or fluid transport and may increase the amount of catalyst surface area that is available for reaction.

The ion-conducting layer 960 may include two or three sublayers: a polymer electrolyte membrane (PEM) 965, an optional cathode buffer layer 925, and/or an optional anode buffer layer 945. One or more layers in the ion-conducting layer may be porous. In certain embodiments, at least one layer is nonporous so that reactants and products of the cathode cannot pass via gas and/or liquid transport to the anode and vice versa. In certain embodiments, the PEM layer 965 is nonporous. Example characteristics of anode buffer layers and cathode buffer layers are provided elsewhere herein. In some embodiments, the ion-conducting layer 960 includes only a PEM and may be an anion-exchange membrane or cation-exchange membrane.

FIG. 10 shows CO₂ electrolyzer 1003 configured to receive water and CO₂ (e.g., humidified or dry gaseous CO₂) as a reactant at a cathode 1005 and expel CO as a product. Electrolyzer 1003 is also configured to receive water as a reactant at an anode 1007 and expel gaseous oxygen. Electrolyzer 1003 includes bipolar layers having an anion-conducting polymer 1009 adjacent to cathode 1005 and a cation-conducting polymer 1011 (illustrated as a proton-exchange membrane) adjacent to anode 1007.

As illustrated in the magnification inset of a bipolar interface 1013 in electrolyzer 1003, the cathode 1005 includes an anion exchange polymer (which in this example is the same anion-conducting polymer 1009 that is in the bipolar layers) electronically conducting carbon support particles 1017, and metal nanoparticles 1019 supported on the support particles. CO₂ and water are transported via pores such as pore 1021 and reach metal nanoparticles 1019 where they react, in this case with hydroxide ions, to produce bicarbonate ions and reduction reaction products (not shown). CO₂ may also reach metal nanoparticles 1019 by transport within anion exchange polymer 1015.

Hydrogen ions are transported from anode 1007, and through the cation-conducting polymer 1011, until they reach bipolar interface 1013, where they are hindered from further transport toward the cathode by anion exchange polymer 1009. At interface 1013, the hydrogen ions may react with bicarbonate or carbonate ions to produce carbonic acid (H₂CO₃), which may decompose to produce CO₂ and water. As explained herein, the resulting CO₂ may be provided in gas phase and should be provided with a route in the MEA back to the cathode 1005 where it can be reduced. The cation-conducting polymer 1011 hinders transport of anions such as bicarbonate ions to the anode where they could react with protons and release CO₂, which would be unavailable to participate in a reduction reaction at the cathode.

As illustrated, a cathode buffer layer having an anion-conducting polymer may work in concert with the cathode and its anion-conductive polymer to block transport of protons to the cathode. While MEAs employing ion conducting polymers of appropriate conductivity types in the cathode, the anode, cathode buffer layer, and if present, an anode buffer layer may hinder transport of cations to the cathode and anions to the anode, cations and anions may still come in contact in the MEA's interior regions, such as in the membrane layer.

As illustrated in FIG. 10, bicarbonate and/or carbonate ions combine with hydrogen ions between the cathode layer and the anode layer to form carbonic acid, which may decompose to form gaseous CO₂. It has been observed that MEAs sometime delaminate, possibly due to this production of gaseous CO₂, which does not have an easy egress path.

The delamination problem can be addressed by employing a cathode buffer layer having pores. One possible explanation of its effectiveness is that the pores create paths for the gaseous carbon dioxide to escape back to the cathode where it can be reduced. In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode.

### Anion Exchange Membrane-Only MEA for COₓ Reduction

In some embodiments, an MEA does not contain a cation-conducting polymer layer. In such embodiments, the electrolyte is not a cation-conducting polymer and the anode, if it includes an ion-conducting polymer, does not contain a cation-conducting polymer. Examples are provided herein.

An anion-exchange membrane (AEM)-only (AEM-only) MEA allows conduction of anions across the MEA. In embodiments in which none of the MEA layers has significant conductivity for cations, hydrogen ions have limited mobility in the MEA. In some implementations, an AEM-only membrane provides a high pH environment (e.g., at least about pH 7) and may facilitate CO₂ and/or CO reduction by suppressing the hydrogen evolution parasitic reaction at the cathode. As with other MEA designs, the AEM-only MEA allows ions, notably anions such as hydroxide ions, to move through polymer-electrolyte. The pH may be lower in some embodiments; a pH of 4 or greater may be high enough to suppress hydrogen evolution. The AEM-only MEA also permits electrons to move to and through metal and carbon in catalyst layers. In embodiments, having pores in the anode layer and/or the cathode layer, the AEM-only MEA permits liquids and gas to move through pores.

In certain embodiments, the AEM-only MEA comprises an anion-exchange polymer electrolyte membrane with an electrocatalyst layer on either side: a cathode and an anode. In some embodiments, one or both electrocatalyst layers also contain anion-exchange polymer-electrolyte.

In certain embodiments, an AEM-only MEA is formed by depositing cathode and anode electrocatalyst layers onto porous conductive supports such as gas diffusion layers to form gas diffusion electrodes (GDEs) and sandwiching an anion-exchange membrane between the gas diffusion electrodes.

In certain embodiments, an AEM-only MEA is used for CO₂ reduction. The use of an anion-exchange polymer electrolyte avoids low pH environment that disfavors CO₂ reduction. Further, water is transported away from the cathode catalyst layer when an AEM is used, thereby preventing water build up (flooding) which can block reactant gas transport in the cathode of the cell.

Water transport in the MEA occurs through a variety of mechanisms, including diffusion and electro-osmotic drag. In some embodiments, at current densities of the CO₂ electrolyzers described herein, electro-osmotic drag is the dominant mechanism. Water is dragged along with ions as they move through the polymer electrolyte. For a cation-exchange membrane such as Nafion membrane, the amount of water transport is well characterized and understood to rely on the pre-treatment/hydration of the membrane. Protons move from positive to negative potential (anode to cathode) with each carrying 2-4 water molecules with it, depending on pretreatment. In anion-exchange polymers, the same type of effect occurs. Hydroxide, bicarbonate, or carbonate ions moving through the polymer electrolyte will ‘drag’ water molecules with them. In the anion-exchange MEAs, the ions travel from negative to positive voltage, so from cathode to anode, and they carry water molecules with them, moving water from the cathode to the anode in the process.

In certain embodiments, an AEM-only MEA is employed in CO reduction reactions. Unlike the CO₂ reduction reaction, CO reduction does not produce carbonate or bicarbonate anions that could transport to the anode and release valuable reactant.

FIG. 11 illustrates an example construction of a COₓ reduction MEA 1101 having a cathode catalyst layer 1103, an anode catalyst layer 1105, and an anion-conducting PEM 1107. In certain embodiments, cathode catalyst layer 1103 includes metal catalyst particles (e.g., nanoparticles) that are unsupported or supported on a conductive substrate such as carbon particles. In some implementations, cathode catalyst layer 1103 additionally includes an anion-conducting polymer. The metal catalyst particles may catalyze COx reduction, particularly at pH greater than a threshold pH, which may be pH 4-7, for example, depending on the catalyst. In certain embodiments, anode catalyst layer 405 includes metal oxide catalyst particles (e.g., nanoparticles) that are unsupported or supported on a conductive substrate such as carbon particles. In some implementations, anode catalyst layer 1103 additionally includes an anion-conducting polymer. Examples of metal oxide catalyst particles for anode catalyst layer 1105 include iridium oxide, nickel oxide, nickel iron oxide, iridium ruthenium oxide, platinum oxide, and the like. Anion-conducting PEM 1107 may comprise any of various anion-conducting polymers such as, for example, HNNS/HNN8 by Ionomr, FumaSep by Fumatech, TM1 by Orion, PAP-TP by W7energy, Sustainion by Dioxide Materials, and the like. These and other anion-conducting polymer that have an ion exchange capacity (IEC) ranging from 1.1 to 2.6 mmol/g, working pH ranges from 0-14, bearable solubility in some organic solvents, reasonable thermal stability and mechanical stability, good ionic conductivity/ASR and acceptable water uptake/swelling ratio may be used. The polymers may be chemically exchanged to certain anions instead of halogen anions prior to use. In some embodiments, the anion-conducting polymer may have an IEC of 1 to 3.5 mmol/g.

As illustrated in FIG. 11, COₓ such as CO₂ gas may be provided to cathode catalyst layer 1103. In certain embodiments, the CO₂ may be provided via a gas diffusion electrode. At the cathode catalyst layer 1103, the CO₂ reacts to produce reduction product indicated generically as CₓO_{y}H_{z}. Anions produced at the cathode catalyst layer 403 may include hydroxide, carbonate, and/or bicarbonate. These may diffuse, migrate, or otherwise move to the anode catalyst layer 1105. At the anode catalyst layer 1105, an oxidation reaction may occur such as oxidation of water to produce diatomic oxygen and hydrogen ions. In some applications, the hydrogen ions may react with hydroxide, carbonate, and/or bicarbonate to produce water, carbonic acid, and/or CO₂. Fewer interfaces give lower resistance. In some embodiments, a highly basic environment is maintained for C₂ and C₃ hydrocarbon synthesis.

FIG. 12 illustrates an example construction of a CO reduction MEA 1201 having a cathode catalyst layer 1203, an anode catalyst layer 1205, and an anion-conducting PEM 1207. Overall, the constructions of MEA 1201 may be similar to that of MEA 1101 in FIG. 11. However, the cathode catalyst may be chosen to promote a CO reduction reaction, which means that different reduction catalysts would be used in CO and CO₂ reduction embodiments.

In some embodiments, an AEM-only MEA may be advantageous for CO reduction. The water uptake number of the AEM material can be selected to help regulate moisture at the catalyst interface, thereby improving CO availability to the catalyst. AEM-only membranes can be favorable for CO reduction due to this reason. Bipolar membranes can be more favorable for CO₂ reduction due to better resistance to CO₂ dissolving and crossover in basic anolyte media.

In various embodiments, cathode catalyst layer 1203 includes metal catalyst particles (e.g., nanoparticles) that are unsupported or supported on a conductive substrate such as carbon particles. In some implementations, cathode catalyst layer 1203 additionally includes an anion-conducting polymer. In certain embodiments, anode catalyst layer 1205 includes metal oxide catalyst particles (e.g., nanoparticles) that are unsupported or supported on a conductive substrate such as carbon particles. In some implementations, anode catalyst layer 1203 additionally includes an anion-conducting polymer. Examples of metal oxide catalyst particles for anode catalyst layer 1205 may include those identified for the anode catalyst layer 1105 of FIG. 11. Anion-conducting PEM 1207 may comprise any of various anion-conducting polymer such as, for example, those identified for the PEM 1107 of FIG. 11.

As illustrated in FIG. 12, CO gas may be provided to cathode catalyst layer 12. In certain embodiments, the CO may be provided via a gas diffusion electrode. At the cathode catalyst layer 1203, the CO reacts to produce reduction product indicated generically as CₓO_{y}H_{z}.

Anions produced at the cathode catalyst layer 1203 may include hydroxide ions. These may diffuse, migrate, or otherwise move to the anode catalyst layer 1205. At the anode catalyst layer 1205, an oxidation reaction may occur such as oxidation of water to produce diatomic oxygen and hydrogen ions. In some applications, the hydrogen ions may react with hydroxide ions to produce water.

While the general configuration of the MEA 1201 is similar to that of MEA 1201, there are certain differences in the MEAs. First, MEAs may be wetter for CO reduction, helping keep the polymer electrolyte hydrated. Also, for CO₂ reduction, a significant amount of CO₂ may be transferred to the anode for an AEM-only MEA such as shown in FIG. 12. For CO reduction, there is less likely to be significant CO gas crossover. In this case, the reaction environment could be very basic. MEA materials, including the catalyst, may be selected to have good stability in high pH environment. In some embodiments, a thinner membrane may be used for CO reduction than for CO₂ reduction.

As a person skilled in the art will recognize from the previous detailed description and from the figures and claims, modifications and changes can be made to the disclosed embodiments of the disclosure without departing from the scope of this disclosure defined in the following claims.

1. A system for producing a gas phase multielectron product, comprising:
a carbon dioxide (CO₂) reduction reactor comprising a membrane electrode assembly that comprises one or more ion conductive polymer layers and a cathode catalyst for facilitating chemical reduction of carbon dioxide to carbon monoxide;
a carbon oxide (COₓ) reduction reactor comprising an anion-exchange membrane (AEM)-only membrane electrode assembly (MEA) that comprises one or more ion conductive polymer layers and a cathode catalyst for facilitating chemical reduction of carbon oxide to the gas phase multielectron product, the COₓ reduction reactor configured to receive an intermediate product stream comprising carbon monoxide (CO) and unreacted CO₂ from the CO₂ reduction reactor, reduce CO to the multielectron gas phase product, convert at least some of the unreacted CO₂ to bicarbonate, transport the bicarbonate to the anode side of the AEM-only MEA, and output a cathode-side gas phase product stream comprising the multielectron product, wherein the amount of CO₂ in the gas phase product stream is less than the amount in the intermediate gas phase product stream.

2. The system of claim 1, wherein the CO₂ reduction reactor comprises a bipolar MEA.

3. The system of claim 1, wherein the CO₂ reduction reactor comprises a cation exchange membrane-only MEA.

4. The system of claim 1, wherein the CO₂ reduction reactor and the COₓ reduction reactor each comprise a stack of electrochemical cells each comprising an MEA.

5. The system of claim 1, wherein the COₓ reduction reactor is configured to output an anode-side stream comprising O₂ and CO₂, the system further comprising a separator configured to separate the CO₂ and the O₂ in the anode-side stream; and a mixing unit configured to mix fresh CO₂ with separated CO₂ for inlet to the CO₂ reduction reactor.

6. The system of claim 1, wherein the COₓ reduction reactor is configured to output an anode-side stream comprising CO₂, the system further a recycle loop configured to recycle the CO₂ from the anode-side stream to the CO₂ reduction reactor.

7. The system of claim 1, wherein the COₓ reduction reactor is configured to output an anode-side stream comprising CO₂ and O₂, the system further comprising a separator configured to separate the CO₂ and the O₂ in the anode-side stream; and a mixing unit configured to mix fresh CO₂ with separated CO₂ for inlet to the CO₂ reduction reactor.

8. The system of claim 1, wherein the cathode catalyst for facilitating chemical reduction of carbon dioxide to carbon monoxide comprises gold.

9. The system of claim 1, wherein the cathode catalyst for facilitating chemical reduction of carbon oxide to the gas phase multielectron product comprises copper.

10. The system of claim 1, wherein the gas phase multielectron product is methane (CH₄).

11. The system of claim 1, wherein the gas phase multielectron product is ethylene (CH₂CH₂).

12. A system for producing CO, comprising:
a carbon dioxide (CO₂) reduction reactor comprising a membrane electrode assembly that comprises one or more ion conductive polymer layers and a cathode catalyst for facilitating chemical reduction of carbon dioxide to carbon monoxide;
a carbon oxide (COₓ) reduction reactor comprising an anion-exchange membrane (AEM)-only membrane electrode assembly (MEA) that comprises one or more ion conductive polymer layers and a cathode catalyst for facilitating chemical reduction of carbon dioxide, the COₓ reduction reactor configured to receive an intermediate product stream comprising carbon monoxide (CO) and unreacted CO₂ from the CO₂ reduction reactor, convert at least some of the unreacted CO₂ to bicarbonate, transport the bicarbonate to the anode side of the AEM-only MEA, and output a cathode-side gas phase product stream comprising CO, wherein the amount of CO₂ in the gas phase product stream is less than the amount in the intermediate gas phase product stream.

13. The system of claim 12, wherein the CO₂ reduction reactor comprises a bipolar MEA.

14. The system of claim 12, wherein the CO₂ reduction reactor comprises a cation exchange membrane-only MEA.

15. The system of claim 12, wherein the CO₂ reduction reactor comprises a stack of electrochemical cells each comprising an MEA and the COₓ reduction reactor comprises a stack of electrochemical cells each comprising an MEA.

16. The system of claim 12, wherein the COₓ reduction reactor is configured to receive a carbon-containing anode-side feed stream.

17. A system for producing a gas phase product, comprising:
a carbon dioxide (CO₂) reduction reactor comprising an anion-exchange membrane (AEM)-only membrane electrode assembly (MEA) that comprises a cathode catalyst for facilitating chemical reduction of CO₂ to the gas phase product; the CO₂ reduction reactor configured to reduce CO₂ to the gas phase product, convert at least some unreacted CO₂ to bicarbonate, transport the bicarbonate to the anode side of the AEM-only MEA for reaction to CO₂, output a cathode-side gas phase product stream comprising the product, and output an anode-side stream comprising O₂ and CO₂;
a separator configured to separate the CO₂ and the O₂ in the anode-side stream; and
a mixing unit configured to mix fresh CO₂ with separated CO₂ for inlet to the CO₂ reduction reactor.

18. The system of claim 17, wherein the gas phase product is carbon monoxide (CO).

19. The system of claim 17, wherein the gas phase product is a gas phase multielectron product.

20. The system of claim 19, wherein the gas phase multielectron product is methane (CH₄).

21.-59. (canceled)
